(19) United States
(12) Patent Application Publication
(10) Pub. No.: US 2026/0028777 A1
(43) Pub. Date: Jan. 29, 2026

(54) A SCK PAPER COMPRISING BCTMP AND RECYCLED PULP

(71) Applicant: UPM-KYMMENE CORPORATION, Helsinki (FI)

(72) Inventor: Jukka KOTILAINEN, Helsinki (FI)

(21) Appl. No.: 19/143,834

(22) PCT Filed: Dec. 21, 2023
(86) PCT No.: PCT/FI2023/050725

§ 371 Date: Jun. 26, 2025

Related U.S. Application Data
(63) Continuation-in-part of application No. 18/113,743, filed on Feb. 24, 2023, now Pat. No. 12,473,693.

(30) Foreign Application Priority Data
Dec. 30, 2022 (EP) 22217245.4
Dec. 30, 2022 (FI) 20226184
Sep. 19, 2023 (WO) PCT/EP2023/075765

(51) Int. Cl. D21H 11/04; C09J 7/40; D21H 11/20; D21H 25/00; D21H 25/04

(52) U.S. Cl. CPC D21H 11/04; C09J 7/405; D21H 11/20; D21H 25/005; D21H 25/04

(57) ABSTRACT

The invention relates to a method for manufacturing SCK paper having a basis weight in the range of 50 to 100 g/m², wherein an optimal combination of nonrecycled BCP, BCTMP and recycled pulp obtained from release liner supercalendered Kraft paper is used to adjust the properties of the fiber furnish. While the use of BCTMP enables a product having a higher bulk, the recycled pulp component, which has high compatibility with the paper manufacturing process, enables to balance the manufacturing process and reduce the dimensional changes and shrinkage of the formed SCK paper. The combined presence of the BCTMP and the recycled pulp component in the fiber furnish improves the water removal from the fibers during the SCK paper manufacturing, while the presence of non-recycled BCP produced from softwood improves the formation and runnability of the paper web on the paper machine. This enables to produce SCK paper with improved sustainability, wherein the density may be controlled by means of the fiber furnish, without downgauging and without adverse effects to other paper properties, which would prevent the use of the SCK paper as substrate layer in a release liner.

### FIELD OF THE INVENTION

The invention relates to a supercalendered kraft paper suitable for use as a substrate layer of an industrial release liner for adhesive labels having a basis weight in the range of 50-100 g/m², which contains bleached chemical pulp, bleached chemithermomechanical pulp, and recycled pulp obtained from a release liner wherein supercalendered kraft paper has been used as a substrate layer. The invention further relates to a method for manufacturing such supercalendered kraft paper and to a release liner, which contains such supercalendered kraft paper.

### BACKGROUND

The packaging industry is booming and adhesive labels are in high demand. As a result of this, the label industry is trying to increase the speed of the existing labelling processes, to meet this demand. This resonates to the supply chain, all the way down to the global pulp production. Release liner plays a significant role in the production and exploitation of adhesive labels. Hence, there is a need for improved ways of producing papers suitable for release liners, which is challenging, however, due to the high quality and functionality expected from these paper types.

A release liner refers to a product comprising a substrate layer and a release coating, such as a silicon polymer based compound, applied on at least one side of the substrate layer. Release liners are widely used as backing materials in labelling applications with adhesive labels, which explains the expectation of high quality. The substrate layer should have sufficient characteristics to withstand the stresses applied at today's high-speed automated labelling processes. The substrate layer typically comprises a paper and a primer coating applied on at least one side of the paper. Examples of paper types suitable for use as release liner substrate layers are glassine paper, supercalendered kraft paper, hereafter denoted as SCK paper, and clay coated paper. Conventionally, to meet the quality expectations, highly refined bleached chemical pulp, such as bleached kraft pulp, hereafter denoted as BKP, is used for manufacturing a paper suitable for use as a substrate layer of an industrial release liner. The amount of bleached chemical pulp from hardwood in the pulp mixture is typically high, in order to obtain a good formation and a paper having sufficient incompressibility, smoothness and dense structure. Prior to release coating the paper is also supercalendered, to increase the transparency and to provide a dense and smooth surface and a desired target thickness which meets the tolerance level set by the die-cutting system. Label producers use a release liner as a substrate for producing a face stock, from which the adhesive labels are cut. Minimal variation of release liner thickness is desired, to facilitate an even die strike pattern at a depth needed for the intended application. Different depth of impression left by the blades is used for different applications. High level of transparency is needed from the paper, since optical sensors are widely used for tracking the position of the labels on the release liner. Typically the optical sensors measure the brightness variation of a light beam, such as an infrared light beam, which is transmitted through a release liner.

In theory, one option for the paper manufacturer to alleviate the shortage of raw material could be to simply reduce the basis weight of the paper upon manufacturing, whereby less amount of pulp would be consumed. The basis weight, as used herein, refers to the grammage of the paper, in grams per square meter. To preserve the quality characteristics, however, the loss of fiber furnish would require compensation by calendering the paper more, which would lead into downgauging, that is, reduction of the paper thickness. A thinner paper having less basis weight would be a different product, in many aspects. A different die strike depth would likely be needed, for the die-cutting system. The paper product would no longer have the same properties as earlier, either, and the risk of inducing adverse effects downstream, when the paper is part of a release liner, is increased. The mechanical properties of the paper, such as surface smoothness, surface density and tearing resistance, may suffer to an extent that a release liner manufactured from such paper would not function properly, when exposed to the conditions present in a labelling process. This is of particular concern with papers having a basis weight in the range of 50-100 g/m²; the relative tolerance levels set by the label converter due to the die-cutting systems become stricter towards the lower end of this basis weight range. Glassine paper is an example of a product type from which superior runnability and almost standardized target values are demanded, throughout the whole value chain.

Bleached chemithermomechanical pulp, hereafter denoted as BCTMP, is material which is appreciated by paper manufacturers as it offers a cost-efficient way to increase the bulk of the paper and to maintain the ratio between the basis weight and the thickness within a desired range. While this may reduce the basis weight, the risk remains that the produced paper does not meet the label converter's expectations in respect of other quality characteristics, when considering use as a substrate layer of an industrial release liner. BCTMP is high yield pulp manufactured by a hybrid process, wherein wood chips are first pre-treated with chemicals, heated for a short period and subsequently refined by mechanical means. This produces pulp having a yield typically in the range of 80 to 95 wt. %, wherein compounds other than cellulose present in the wood material have been preserved to a large extent. The properties of BCTMP thus differ from the properties of bleached chemical pulp, hereafter denoted as BCP. Controlling the density of the paper together with other quality characteristics at a higher production speed on a paper machine becomes more complex, however when BCTMP is added. The addition of BCTMP affects the mechanical and optical properties of the produced paper, such as transparency. The flaws of a produced paper, when considering suitability for release liner applications, may not become evident, however, until the paper has already been manufactured and even siliconized, which would make the recycling of the product more difficult, as well. A dilemma therefore exists in how to ensure that the SCK paper being manufactured will achieve sufficient quality for the intended purpose.

In addition to the quality aspect, also sustainability has become a prominent issue, which needs to be considered in the production of specialty papers. Sustainability comprises both environmental aspects related to preserving biodiversity and aspects related to circular economy, by increasing the recycling of materials. Sustainability may also include responsible sourcing of raw material for an industrial production process. The nature and origin of the wood-based raw material has a significant effect on the sustainability of an industrially produced paper product, since the production volumes are large, as explained above.

### SUMMARY

The invention solves the challenges disclosed above by providing a method for manufacturing supercalendered kraft paper having a basis weight in the range of 50 to 100 g/m², wherein an optimal combination of non-recycled BCP, BCTMP, and recycled pulp obtained from release liner wherein the substrate has been SCK paper, is used to adjust the properties of the fiber furnish.

SCK paper is a distinguished type of paper that is used as a release liner substrate due to its outstanding characteristics. As disclosed above, SCK paper is typically produced of highly refined BCP produced in a kraft process. BCP produced in a kraft process may be referred to as bleached kraft pulp and denoted as BKP. Bleached hardwood kraft pulp is hereafter abbreviated as BHKP. Bleached softwood kraft pulp is hereafter abbreviated as BSKP. The chemical cooking preserves the characteristics of the fibers in the pulp better in comparison to mechanical pulping methods, whereby the chemically pulped fibers may be better used for providing strength to the produced paper. Bleaching, in turn, removes residual lignin still present after the chemical cooking operation, which increases the pulp whiteness and brightness. The whiteness of SCK paper is obtained without external dyes or colorants. A SCK paper typically contains a fiber furnish that includes both BSKP as well as BHKP. Different wood species produce different type of fibers, hence the origin of the pulp, in addition to the pulping method, may be used for adjusting the characteristics of the produced paper. For instance, BHKP in general is advantageous, in comparison to BCTMP, for the brightness and transparency of the product. The specifications of the produced paper may thus be altered by means of adjusting the share of pulp in a fiber furnish. The challenge, as indicated above, is that when the amount of a given pulp component is adjusted, it typically has an effect to several other paper characteristics. Thus, a dilemma lies in the multivariable optimization—how to improve desired paper characteristics without deteriorating others to the extent that the paper no longer meets the set quality specifications for the intended purpose.

SCK paper is manufactured on a paper machine by forming a paper web from selected pulp types which have been mixed together, such that a pulp mixture has been obtained. Automated optical analysis using unpolarized light may be used for determining the properties and fiber furnish of the pulp mixture, whereby for example fibers produced by chemical or mechanical pulping methods and their dimensions may be identified. The moisture content of the paper web is reduced in a press section, after which the paper web is dried in a drying section, whereby paper is formed. The ultimate properties of SCK paper manufactured at a paper machine, such as transparency and target thickness, are obtained by supercalendering, which is performed using a line pressure, heat and moisture content that are higher than conventionally used during an ordinary calendering treatment. Supercalendering enables to produce kraft paper having high density surface and high transparency. However, the level of compression used in the calendering process is less than is typically used for glassine paper, whereby the surface roughness is higher and the fiber structures of SCK paper are less damaged during the calendering. While SCK paper still displays excellent strength properties and relatively high transparency, it can be produced into technical specification ranges that are broader than for glassine paper. Thus, SCK paper is not glassine paper. Moreover, the whiteness and brightness of SCK paper is due to the fiber characteristics, without added dyes or optical brightening agents, which also distinguishes it from glassine papers, which may be dyed. The method for manufacturing SCK paper is thus more pliable for changes, also in respect of fiber furnish compositions.

Considering the characteristics of highly refined BKP, the replacement of such BKP in a fiber furnish with BCTMP is not straightforward, should the mechanical and optical properties of the produced paper be maintained. As disclosed above, the manufacturing method of BCTMP differs from BKP. The two pulp types thus differ in many aspects. This can be seen in the mass of the particles in fiber length fractions in BCTMP, for instance. The distribution of the mass of the particles in fiber length fractions differs considerably from those in BHKP. It also differs significantly from the mass of the particles in fiber length fractions in BSKP. When considering the characteristics of BCTMP, the mass of the particles in shorter fiber length fractions, up to 1.2 mm in length, forms majority of the total mass, while in BSKP, the opposite seems to be the case. In BSKP, mass of the particles in longer fiber length fractions having a length equal to or higher than 1.2. mm appears to be dominant, when determined with Valmet Fiber Image Analyzer (Valmet FS5), implementing ISO 16065-2:2014, ISO 9184-4 and ISO 9184-1. This can also be seen in fiber length distribution of the BCTMP that differs considerably from fiber length distribution of the BHKP and particularly of the fiber length distribution of the BSKP. The gist thus lies in understanding how the underlying properties of the different type of pulps may be optimally used together in SCK paper to reduce the basis weight while preserving the thickness, in a way which prevents other relevant quality characteristics from falling out of specifications.

Experimental studies indicate that SCK paper having a low basis weight is exceptionally suitable for the adjustment of density with BCTMP. The results further indicate that SCK paper having a low basis weight, preferably in the range of 50-100 g/m², most preferably in the range of 50-70 g/m², and wherein the amount of BSKP is equal to or higher than 15 wt. % (SCAN P 39:80), enables very effective basis weight reduction, when BCTMP is used in an amount equal to or higher than 5 wt. % to replace BHKP. Uncalendered paper sheets, which contained BCTMP in the range of 5 to 50 wt. %, when determined as dry matter content of the paper, demonstrated a considerable increase of bulk. The uncalendered paper sheets, when exposed to conditions corresponding to industrial supercalendering, can also be calendered into the same thickness as corresponding industrial SCK papers, which contain only BHKP and BSKP. When the content of BCTMP was increased from 5 to 50 wt. %, the observed effect of BCTMP into the thickness of SCK paper was 4% in SCK paper having a basis weight of 58 g/m², 6% in SCK paper having a basis weight of 62 g/m², and 11% in SCK paper having a basis weight of 68 g/m². The combination thus enables to reduce the basis weight of the SCK paper, without downgauging.

The bulk increase obtainable when replacing BHKP with BCTMP is particularly interesting in SCK paper grades having a density in the range of 1030 to 1190 kg/m³, wherein the bulk may be flexibly controlled with the share of BCTMP in the fiber furnish, while using the share of BSKP to adjust other paper characteristics, such as tear strength of the paper. Further, the substitution of

BHKP with BCTMP enables to maintain or even increase bending stiffness of the SCK paper, whereby a good potential to resist compression, which facilitates an even die strike pattern during a die-cutting operation, is obtainable. Experimental results indicate that SCK paper containing a combination of BCTMP and BSKP, as disclosed above, still possesses a tear index higher than 5 mNm²/g (ISO 1974), which is sufficiently high for use as a substrate layer of an industrial release liner for adhesive labels. The tear index in the cross direction of the paper is particularly advantageous, considering the use as a substrate layer in labelling processes.

Further experiments indicate that in addition to bleached kraft pulp and BCTMP, also a specific type of recycled pulp obtained from release liner, wherein the substrate is supercalendered Kraft paper, may be added into the fiber furnish of an SCK paper to further adjust the characteristics of the fiber furnish. A release liner, wherein the substrate is supercalendered Kraft paper, is hereafter referred to as release liner supercalendered Kraft paper and abbreviated as RSCK.

RSCK recycling provides means for supercalendered Kraft paper production to be more sustainable, while being compatible for solving challenges mentioned above. Fibers of RSCK display signs of damages due to extensive hornification and no longer have the same characteristics as fibers of virgin BCP made of softwood. However, sorting of RSCK apart from other paper waste provides specific and highly homogeneous material for recycling, which enables to better adjust characteristics of the material already during the recycling process. This is advantageous, as the compatibility of the recycled pulp can thus be adapted and optimized for supercalendered Kraft paper production. In particular, recycled pulp produced from RSCK may be used to replace non-recycled BHKP and BSKP in the composition of the supercalendered Kraft paper. A more closed loop is therefore possible for the papermaking fibers.

The properties of BCTMP and recycled pulp obtained from RSCK are in some aspects similar, such as in the water retention capability of the fibers, which is relevant for the behaviour of the fiber furnish upon manufacturing SCK paper. Water retention value, abbreviated as WRV, is an empirical measure of the capacity of a pulp sample to hold water, determinable according to ISO 23714:2014(en). Both RSCK and BCTMP typically comprise a low water retention capability. The amount of recycled pulp obtained from RSCK may therefore be used to further control the dry matter content of the stock, upon forming the paper web. The reduced ability of the recycled pulp obtained from RSCK to absorb moisture also leads to enhanced dewatering of the paper web, already at the press section of the paper machine.

On the other hand, the properties of BCTMP and recycled pulp obtained from RSCK are different in other aspects. Due to a different method of pulp production, BCTMP comprises more lignin than chemical pulp or recycled pulp obtained from RSCK. This enables BCTMP fibers to resist compression better during supercalendering than recycled pulp obtained from RSCK. Hence, BCTMP is excellent for increasing the bulk of a SCK paper. Due to a different method of pulp production, recycled pulp obtained from RSCK comprises better strength properties and less dirt specks than BCTMP. Fiber characteristics of recycled pulp obtained from RSCK are closer to hardwood chemical pulp in terms of fiber length, fiber width and fiber fraction distribution, than those of BCTMP. Also the optical properties of recycled pulp obtained from RSCK, such as transparency and brightness, are closer to hardwood chemical pulp than those of BCTMP.

The combined use of BCTMP and recycled pulp obtained from RSCK in a fiber furnish upon manufacturing SCK paper enables compounded effects, such as reduced refining, improved dewatering and more efficient drying. These are observable for instance by methods, which measure the water retention and drying behaviour of the paper web. When the amount of BCTMP and recycled pulp obtained from RSCK in the stock is increased, the water retention value decreases. This indicates that less water needs to be removed on the press section, during supercalendered Kraft paper production. Recycled pulp obtained from RSCK also improves the dimensional stability and reduces the shrinkage of the formed paper, upon drying. The presence of RSCK in a fiber furnish may hence be used as a component which balances adverse effects of BCTMP, during SCK paper manufacturing.

Pulp analyses from a paper mill further indicate that replacement of non-recycled BKP with recycled pulp obtained from RSCK in a pulp mixture results to an increase in the fines content in the pulp mixture, when determined as the F<200 fraction with McNett classifier according to SCAN-CM 6:05. This indicates, that recycled pulp obtained from RSCK may be used to adjust the quality of the paper web formed on the paper machine.

Experimental results indicate positive effects also downstream in the supercalendered Kraft paper production process. Drainability is related to the surface conditions and swelling of the fibres and is an indicator of the amount of mechanical treatment to which the pulp has been subjected. A paper web, which contains recycled pulp obtained from RSCK, demonstrates improved drainage on a paper machine. A higher amount of the recycled pulp obtained from RSCK in the stock correlates with the level of drainage, such that less steam pressure is needed for drying. Unexpectedly, a reduction of 0.1 bar in the steam pressure may be obtained already with an amount of 5 wt. % of recycled pulp obtained from RSCK in the composition, when drying the supercalendered Kraft paper. When the amount of recycled pulp obtained from RSCK in the composition is 15 wt. %, 0.3 bar less of steam pressure may be used for drying the supercalendered Kraft paper. A considerable amount of energy may thus be saved.

The combined use of BCTMP and recycled pulp obtained from RSCK enables to maintain quality characteristics of supercalendered Kraft paper at a sufficient level, with enhanced sustainability and without reducing the basis weight of the paper upon manufacturing. Experimental results from SCK paper specimens indicate that a fiber furnish containing BCTMP and recycled pulp obtained from RSCK, each independently in the range of 5 to 40 wt. % when determined as dry matter content of the paper, may be supercalendered into a target thickness corresponding to similar kraft papers without BCTMP and recycled pulp obtained from RSCK, while maintaining a sufficiently high density and a transparency level.

A sufficient level of quality characteristics, in this context, refers to a supercalendered Kraft paper having a density in the range of 1.030 to 1.190 g/cm³, and a transparency in the range of 36 to 56%. Advantageously the density is in the range of 1.050 to 1.190 g/cm³, most preferably in the range of 1.060 to 1.180 g/cm³, determinable by standard ISO 534. On this density range, the reduction in basis weight with BCTMP has been observed to have a particular cost advantage. The optimization of the fiber furnish composition also facilitates to maintain a sufficient transparency of the supercalendered kraft paper. Advantageously the transparency is in the range of 38 to 54%, most preferably in the range of 40 to 52%, determinable by standard ISO 2469. The combination of density and transparency is of relevance, as these can be used as indications of the supercalendered Kraft paper having a sufficient incompressibility and smoothness. A supercalendered Kraft paper, which is intended to be used as a release liner substrate, needs suitably low compressibility in the thickness direction S_{z} parallel to surface normal of the paper, as the release liner typically acts as backing material for face material comprising an adhesive layer. The face material is shaped into labels with cutting die that is pressed against the face material with a predefined pressure. When the release liner substrate exhibits suitably low compressibility, the blades cut through the face material into a predefined depth, such that the face material comprising the adhesive layer may be stripped away around the cut area without damaging the substrate. The combination of density and transparency therefore indicates the suitability of the supercalendered Kraft paper to function as a release liner substrate for adhesive labels.

Hence, according to a first aspect and as indicated above, there is provided a supercalendered Kraft paper suitable for use as a substrate of a release liner, the supercalendered Kraft paper having
a grammage in the range of 50 to 100 g/m², determinable according to ISO 536
a density equal to or higher than 1.030 g/cm³, determinable according to ISO 534,
a transparency equal to or higher than 36%, determinable according to ISO 2469, and
a fiber furnish determinable with standard ISO 9184-4 in conjunction with standard ISO 9184-1, the fiber furnish comprising
   an amount equal to or higher than 5 wt. % of non-recycled bleached chemithermomechanical pulp, and
   an amount equal to or higher than 5 wt. % of recycled pulp obtained from release liner supercalendered Kraft paper,
   the fiber furnish further comprising
   non-recycled bleached chemical pulp produced from hardwood,
   non-recycled bleached chemical pulp produced from softwood or
   non-recycled bleached chemical pulp produced from hardwood and softwood,
the amounts determinable as dry matter content according to SCAN-P 39:80.

Further, according to a second aspect and as indicated above, there is provided a method for manufacturing supercalendered Kraft paper suitable for use as a substrate of a release liner, the method comprising
mixing pulps such that a stock comprising a fiber furnish is obtained, the fiber furnish determinable with standard ISO 9184-4 in conjunction with standard ISO 9184-1, the fiber furnish comprising
   an amount equal to or higher than 5 wt. % of non-recycled bleached chemithermomechanical pulp,
   an amount equal to or higher than 5 wt. % of recycled pulp obtained from release liner supercalendered Kraft paper, and
   non-recycled bleached chemical pulp produced from hardwood,
   non-recycled bleached chemical pulp produced from softwood or
   non-recycled bleached chemical pulp produced from hardwood and softwood
   the amounts determinable as dry matter content according to SCAN-P 39:80,
forming a paper web of the stock on a paper machine,
reducing moisture content of the paper web in a press section,
drying the paper web in a drying section, thereby forming paper, and
supercalendering the paper, thereby forming supercalendered Kraft paper having
a grammage in the range of 50 to 100 g/m², determinable according to ISO 536,
a density equal to or higher than 1.030 g/cm³, determinable according to ISO 534, and
a transparency equal to or higher than 36%, determinable according to ISO 2469.

Further still, there is provided a release liner comprising a substrate layer and a release coating, wherein the substrate layer is a supercalendered kraft paper as indicated above, which comprises a primer coating applied on at least one side of the supercalendered kraft paper. The primer coating is typically a surface sizing applied in the range of 1 to 5 g/m² per side. The prime coating typically contains water-soluble polymers, such as starch, polyvinyl alcohol and/or carboxymethyl cellulose, which are compatible with addition-curing silicone systems used in release coatings.

Preferably, the supercalendered Kraft paper has a fiber furnish that contains BCTMP in the range of 5 to 40 wt. %, preferably in the range of 10 to 35 wt. %, most preferably in the range of 15 to 30 wt. %. Advantageously, the fiber furnish further contains recycled pulp obtained from release liner wherein the substrate has been SCK paper in the range of 5 to 40 wt. %, preferably in the range of 10 to 35 wt. %, most preferably in the range of 15 to 30 wt. %. Advantageously, the fiber furnish further contains non-recycled BCP produced from softwood at least 15 wt. %, preferably in the range of 15 to 20 wt. % of the fiber furnish. Optimization of the relative shares of non-recycled BCP, BCTMP, and recycled pulp obtained from release liner wherein the substrate has been SCK paper enables production of SCK paper having a basis weight in the range of 50 to 100 g/m² wherein the bulk and density of the may be controlled without downgauging and wherein the SCK paper manufacturing may be performed without adverse effects to other paper properties which would prevent its use as substrate layer of an industrial release liner for adhesive labels. In other words, by selecting optimal shares of BCP, BCTMP, and recycled pulp obtained from release liner wherein the substrate has been SCK paper into a fiber furnish, a bulky SCK paper may be produced, wherein the fiber furnish enables supercalendering of the paper to typical target thickness used for corresponding SCK paper grade having a higher basis weight, which therefore has a higher density and sufficient quality characters for use as a substrate in a release liner. While a fiber furnish comprising a high share of BCTMP enables a product having a higher bulk and improves the water removal from the fibers during the paper manufacturing, the recycled pulp obtained from release liner wherein the substrate has been SCK paper enables to balance the paper manufacturing process and reduce the dimensional changes and shrinkage of the SCK paper, which may also be seen in the paper quality. The presence of recycled pulp obtained from release liner wherein the substrate has been SCK paper further improves the water removal from the fibers during the paper manufacturing. Further, the presence of non-recycled BCP produced from softwood in the fiber furnish has an effect to the formation of the paper web and runnability. By increasing the amount of non-recycled BCP produced from softwood in the fiber furnish the formation and runnability of the paper web on the paper machine may be improved. Thus a SCK paper with optimal shares of BCTMP and recycled pulp in the fiber furnish may be produced into a thickness range typical for higher basis weight products, while maintaining other quality characteristics of the paper sufficient for use as a substrate layer of an industrial release liner.

Most advantageously, the SCK paper as disclosed above has a fiber furnish comprising
BSKP in an amount equal to or higher than 15 wt. %, preferably in the range of 15 to 20 wt. %,
BCTMP in an amount equal to or higher than 15 wt. %, preferably in the range of 15 to 30 wt. %,
recycled pulp obtained from RSCK in an amount equal to or higher than 15 wt. %, preferably in the range of 15 to 30 wt. %, and
an amount BHKP, when needed, such that the total amount of BSKP, BHKP, BCTMP and recycled pulp obtained from RSCK in the fiber furnish together is 100 wt. % of the fiber furnish, when determined as dry matter content of the paper according to SCAN P 39:80.

The invention is defined by the independent and dependent claims.

### DESCRIPTION OF THE DRAWINGS

The symbols Sₓ, S_{z} and S_{y}, as used herein, refer to coordinate directions orthogonal to each other.

FIG. 1 is a diagram showing comparative data of the difference in average mass of fractions (relative share, %) between BCTMP, BHKP and BSKP, when determined with Valmet Fiber Image Analyzer (Valmet FS5), according to the manufacturer's instructions.

FIG. 2 is a diagram showing the effect of BSKP to average length weighted fiber length (mm) in SCK papers having different fiber furnishes.

FIG. 3 is a multivariable diagram showing how tear index (mNm²/g) and basis weight (g/m²) correlate in SCK papers as a function of the BCTMP share (wt. %), determined as dry matter content of the paper according to SCAN-P 39:80.

FIG. 4 is a multivariable diagram showing how tear index (mNm²/g) and basis weight (g/m²) correlate in SCK papers as a function of the BSKP share (wt. %), determined as dry matter content of the paper according to SCAN-P 39:80.

FIG. 5 is a multivariable diagram showing how transparency (%) and basis weight (g/m²) correlate in SCK papers as a function of the BCTMP share (wt. %), determined as dry matter content of the paper according to SCAN-P 39:80.

FIG. 6 is a diagram that illustrates how the characteristics of SCK paper having a basis weight in the range of 50 to 70 g/m² provide an optimization range RNG1, wherein the basis weight of the paper to be produced may be adjusted by means of a fiber furnish composition, while maintaining the target thickness and without inducing adverse effects to other paper properties, which would prevent its use as substrate layer of an industrial release liner for adhesive labels.

FIG. 7 shows, by way of an example, a cross-dimensional structure of a release liner, which comprises a surface sized paper substrate and a release coating.

FIG. 8 shows, by way of an example, a method for manufacturing supercalendered Kraft paper, wherein the method a paper is formed from a stock that contains non-recycled bleached chemical pulp and recycled pulp obtained from supercalendered Kraft paper that has been used as a substrate of a release liner. The supercalendered Kraft paper may be used as a substrate for a release liner. The release liner supercalendered Kraft paper may be recycled and reused in the method for manufacturing supercalendered Kraft paper.

FIG. 9 shows, by way of an example, a method for manufacturing recycled pulp from a release liner supercalendered Kraft paper, which contains a sorting stage, a caustic loop and a cleaning loop for disintegrating fibers and for detaching and removing non-fiber material from the fibers. In addition to the principal functions, the method has been arranged to improve the fiber characteristics such that the recycled pulp may be used without further refining for stock preparation in supercalendered Kraft paper manufacturing.

FIG. 10 shows comparative data of average length in millimeters of fibers in recycled pulp obtained from RSCK vs. non-recycled pulp types, measured using a Valmet Fiber Image Analyzer (Valmet FS5).

FIG. 11 shows comparative data of average fiber width in micrometers of fibers in recycled pulp obtained from RSCK vs. non-recycled pulp types, measured using the Valmet Fiber Image Analyzer (Valmet FS5).

FIG. 12 shows comparative data of the average amount of hydrophobic particles in different pulp types, when measured by means of flow cytometry. The particles have been further sorted based on an average diameter.

FIG. 13 s a trend diagram representing the development of fines content at the machine chest of a paper machine as a function of the amount of recycled pulp obtained from RSCK in the stock, when determined as the F<200 fraction with McNett classifier according to SCAN-CM 6:05.

FIG. 14 is a trend diagram representing the development of water retention value as a function of pulp content, at machine chest of a paper machine. The content of recycled pulp obtained from RSCK correlates inversely with the water retention value. When the content of recycled pulp obtained from RSCK increases, the water retention value decreases.

FIG. 15 is a trend diagram representing the drainage as a function of pulp content, when measured as the main steam group pressure level on a paper machine. The addition of recycled pulp obtained from RSCK reduces the need for steam in the pre-dryer.

FIG. 16 shows comparative data of the development of paper width in centimetres at the reeler of a paper machine, when measured using ABB Web Imaging System (WIS). The results demonstrate that paper shrinkage in the cross-direction S_{y} correlates inversely with the amount of recycled pulp obtained from RSCK in the paper.

FIG. 17 shows comparative data of induced curl of supercalendered Kraft paper, when measured from test pieces in the cross-direction S_{y}. The results demonstrate that the magnitude of curl correlates inversely with the amount of recycled pulp obtained from RSCK in the furnish. Test pieces which contained higher amount of recycled pulp obtained from RSCK displayed less curl.

FIG. 18 shows data of an experimental study performed with computational modelling, which compares effects of different fiber furnish recipes on a SCK paper.

FIG. 19 is data from an experimental study, which compares effect of different fiber furnish recipes on the transparency of SCK paper.

FIG. 20 is data from an experimental study, which compares effect of different fiber furnish recipes on the opacity of SCK paper.

### DETAILED DESCRIPTION

### A Release Liner Supercalendered Kraft Paper

A release liner supercalendered Kraft paper, abbreviated as RSCK, is used to describe a release liner, wherein the substrate is supercalendered Kraft paper. Multiple aspects distinguish RSCK from other paper types collected for recycling.

Supercalendered Kraft paper denotes a specific paper type which is suitable for use as a substrate of a release liner. Supercalendered Kraft paper is conventionally prepared from highly refined bleached chemical pulp that has been strongly calendered, whereby it possesses an exceptional combination of high density, strength and transparency, which are beneficial characteristics for a release liner substrate.

Typical characteristics defining a supercalendered Kraft paper are
smoothness of at least 900 sec/min (ISO 5627),
grammage equal to or less than 100 g/m² (ISO 536),
density equal to or higher than 1.030 g/cm³ (ISO 534), wherein the density refers to grammage (ISO 536) per thickness (ISO 534:2011),
porosity equal to or less than 15000 pm/Pas (ISO 11004), and
transparency of equal to or higher than 36% (ISO 2469), the parameter values corresponding to ISO standards referred in parentheses.

A supercalendered Kraft paper suitable for release liner typically has
a grammage in the range of 50 to 100 g/m² (ISO 536),
a density in the range of 1.030 to 1.190 g/cm³ (ISO 534), and
a transparency in the range of 36 to 56%, (ISO 2469),

A high transparency is preferred, such as in the range of 38 to 54%, most preferably in the range of 40 to 52% (ISO 2469).

The thickness of a supercalendered Kraft paper denotes thickness in micrometers after a calendering treatment, prior to applying a release coating. Thickness, unless otherwise stated, refers to the apparent thickness, determined as single sheet thickness (ISO 534:2011). Supercalendered Kraft paper is calendered with a supercalender before or after applying a primer coating. Calendering enables to produce a supercalendered Kraft paper having high density surface and high transparency, but may lead to moderate reduction in the burst, tensile, and tear strength of the supercalendered Kraft paper. Calendering also reduces the thickness of the supercalendered Kraft paper to a predefined target thickness. Supercalendered Kraft paper is typically surface sized with a primer coating, which is chemically compatible with a silicone polymer release coating. The primer coating can be applied on one or both sides, typically in the range of 1 to 5 g/m², preferably an amount in the range of 1 to 2 g/m² per side is used. A primer coating for supercalendered Kraft paper generally comprises water soluble binders, such as starch, polyvinyl alcohol and/or carboxymethyl cellulose.

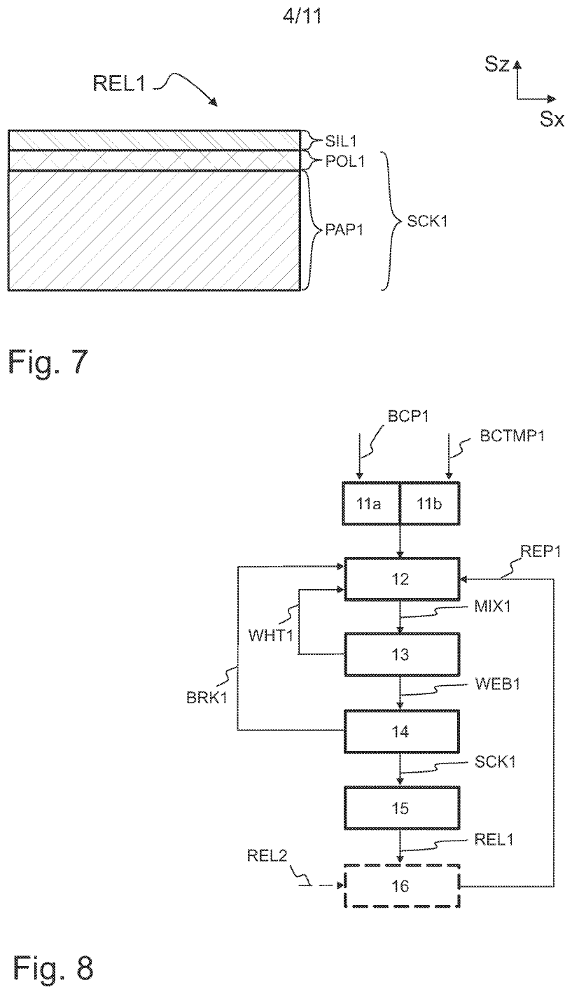

Reference is made to FIG. 7, which, by means of an example, discloses a structural cross-dimensional view of release liner REL1, wherein the substrate SCK1 is a supercalendered Kraft paper. A release liner REL1, in this context, refers to an industrially manufactured paper product, which comprises a dehesive surface coating on at least one side of a calendered paper substrate SCK1. The dehesive surface coating is generally referred to as release coating SIL1. The dehesive surface coating may be used as a protective layer for an adhesive label which contains a face material and an adhesive layer.

A method for manufacturing a release liner REL1 comprises applying a release coating SIL1 on a paper substrate SCK1. The dehesive properties of the release coating SIL1 are typically obtained by means of an addition-curing silicone system in the presence of a suitable metal catalyst, such as platinum. An addition-curing silicone system comprises a reactive silicone polymer and a silane hydride cross-linker comprising functional vinyl groups, which are provided in a fluid form and may be spread on the paper substrate SCK1 in an amount of ca. 1 g/m². The reactive silicone polymer is typically a hydrophobic, silicon-based organic polymer, such as polydimethylsiloxane. When the release coating on the paper is exposed to a cross-linking temperature, typically in the range of 65-150° C., a chemical reaction initiates, which cures the release coating and anchors it on the substrate SCK1. This method enables to obtain a release liner REL1 which comprises a dehesive and hydrophobic surface coating layer based on a cured silicone polymer.

A supercalendered Kraft paper, when used as substrate SCK1 in a release liner REL1, typically comprises a paper PAP1 as support layer and a primer coating POL1. The paper PAP1 is manufactured on a paper machine on a machine direction Sₓ, which refers to the travelling direction of a paper web and paper on the paper machine. The properties of the paper may be different in the machine direction and in a direction perpendicular to the machine direction Sₓ along the surface of the paper, referred to as the cross-direction S_{y}. The paper has a thickness in direction S_{z} parallel to surface normal of the paper. Unlike many other paper types, supercalendered Kraft paper surface is typically not coated with mineral pigments, at least not in significant amounts. A supercalendered Kraft paper, however, in general comprises a primer coating POL1, such as a surface sizing applied on at least one side of the paper. Surface sizing improves the supercalendered Kraft paper surface characteristic, such as barrier properties. An advantageous primer coating POL1 is a water-soluble polyvinyl alcohol comprising hydroxyl groups. Some of the hydroxyl groups of the polyvinyl alcohol may have been modified to comprise reactive groups, such as vinyl groups. This enables the polymer to participate into the cross-linking reaction of the addition-curing silicone system. The primer coating POL1 thereby improves the anchorage of the dehesive surface coating layer to the paper substrate SCK1.

Due to high quality hydrophobic silicone polymers used nowadays in the release coatings for supercalendered Kraft paper, RSCK typically has a stable release value. Thus, after the adhesive labels have been removed, very low amount of adhesive residue remains on the release liner surface. A RSCK which has been used as a carrier for adhesive labels therefore contains very low amounts of adhesive residues.

### A Method for Manufacturing SCK paper on a Paper Machine

SCK paper is manufactured on a paper machine from a pulp mixture. The mixing of the pulps may be performed, for example by homogenising pulp mixture in a mixer. The amount of both BCTMP and recycled pulp obtained from RSCK in the pulp mixture may be independently varied in the range of 5 to 40 wt. %, when determined as dry matter content of the paper (SCAN P 39:80). Typically, a pulp mixture for SCK paper comprises BCP, which contains both BSKP and BHKP. BHKP is advantageous for the brightness and transparency of the product. BSKP has a longer average fiber length than BHKP or BCTMP, and is therefore advantageous for the strength properties of the formed paper web. Typically, the pulps are refined, at a refining section of a paper machine prior to forming the pulp mixture. The pulps may be refined separately, where necessary.

A paper web for SCK is formed from the pulp mixture at a forming section of the paper machine. Typically, at a headbox of a paper machine, a pulp suspension having a consistency between 0.25 and 1 wt. % is used.

Reference is made to FIG. 8, which, by way of an example, presents a method for manufacturing supercalendered Kraft paper, which comprises
refining 11a, 11b of pulps BCP1, BCTMP1,
mixing 12 together pulps BCP1, BCTMP1, REP1, and, optionally, broke BRK1 and white water WHT1, to obtain a stock MIX1,
forming 13 a paper web WEB1 at a headbox of a paper machine, and
forming 14 a supercalendered Kraft paper on the paper machine.

The supercalendered Kraft paper is suitable for use as a substrate SCK1 in a method 15 for manufacturing a release liner REL1. In the method for manufacturing supercalendered Kraft paper, a stock MIX1 is obtained after mixing 12 together different pulps during stock preparation. The mixing may be performed, for example by homogenising the stock MIX1 in a mixer. Stock refers to a pulp mixture from which paper is manufactured on a paper machine. Stock may also be referred to as furnish. Stock is fed to the forming section of a paper machine when manufacturing paper. A pulp suspension is needed to adjust loading upon stock preparation and to control fiber bonding, when forming a paper web 13 at a headbox of a paper machine.

Thus, the stock is typically first fed to a machine chest. A machine chest is a consistency levelling unit, which provides a retention time such that any variations in consistency can be levelled out, prior to pumping the stock to a headbox, where it is dispensed evenly on to a moving wire at the forming section of a paper machine. Consistency is used to describe the percentage of oven dry mass from the total mass. The consistency of oven dry mass is 100%. The machine chest contains a valve system unit arranged to receive feedback from an on-line scanner measuring basis weight, which enables to adjust the basis weight of the paper to be formed.

Stock preparation may comprise loading and refining 11a, 11b of pulp components BCP1, BCTMP1 to provide a pulp mixture with desired characteristics. The pulp components BCP1, BCTMP1 may be refined separately. Depending on the paper to be manufactured, the stock MIX1 may further contain non-fibrous additives, such as sizing agents.

When manufacturing supercalendered Kraft paper comprising recycled pulp obtained from RSCK, the stock may contain both non-recycled bleached chemical pulp BCP1 produced from hardwood, non-recycled bleached chemical pulp BCP1 produced from softwood, non-recycled bleached chemithermomechanical pulp BCTMP1 and recycled pulp obtained from supercalendered Kraft paper that has been used as a substrate of a release liner REP1. Non-recycled pulp, in this context, refers to virgin pulp material which is introduced into a paper manufacturing process for the first time. The non-recycled pulp may be bleached chemical pulp from a Kraft process. The non-recycled pulp may also be BCTMP. The stock MIX1 may contain broke BRK1, which refers to material produced on a paper machine, which is not up to specification, such as paper trimmings. Broke may be recycled back to the paper manufacturing process. Broke may be refined prior to mixing 12. However, broke has undergone at least part of a paper manufacturing process on a paper machine, and hence is not considered to be virgin pulp material, when introduced again into the paper manufacturing process. Broke is not obtained from a release liner REL1, either.

White water WHT1 may also be used, when preparing the stock MIX1. White water is used to describe slurry, which is formed at a forming section of a paper machine, when fine particles present in the stock drain from the formed paper web WEB1 into a pit below the paper machine. White water contains fines suspended in the stock. Fines refers to particles having a width in the range of 10 to 75 micrometers and a length less than 0.2 millimeters. White water may be circulated back into the stock preparation by means of a short circulation of the paper machine or treated and used elsewhere in the papermaking process.

The amount of circulated fines defines a retention level, which describes the ability of the formed paper web to retain fines, and therefore the balance between drainage and formation 13 of the paper web.

On the forming section of the paper machine, after the paper web WEB1 is formed 13 from the pulp suspension and dewatered, the paper web is moved on a press section to reduce the moisture content of the paper web further. The press section of a paper machine typically comprises a number of rolls for guiding and/or pressing the paper web. The paper web is then moved from the press section to a drying section of a paper machine. In the drying section, the paper web is heated to evaporate most of the remaining moisture in the paper web. After drying section, the paper web may have a dry matter content level equal to or more than 90 wt.-%, for example in the range of 90 to 95 wt.-%, when determined according to SCAN-P 39:80. The forming of paper 14 therefore comprises a step for reducing moisture content of the paper web in a press section, and a step for drying the paper web in a drying section, thereby forming paper from a stock MIX1 that contains non-recycled bleached chemical pulp BCP1 from hardwood, non-recycled bleached chemical pulp BCP1 from softwood, non-recycled bleached chemithermomechanical pulp BCTMP1, and recycled pulp obtained from supercalendered Kraft paper that has been used as a substrate of a release liner REP1.

A weight percentage, abbreviated as wt. %, is used to describe a weight fraction of component in a composition. A weight percentage of pulp is used to describe a weight fraction of a pulp in a material. A weight percentage of pulp in a paper denotes the dry weight of the pulp in a dry paper, when determined according to SCANP-39:80 test method for dry matter content. The dry weight of a sample is determined by weighing 20 grams of sample on a dish before and after oven drying at 105° C. and eliminating the mass of the empty dish from the measurement. Oven dry pulp has been dried at 105° C. until its mass is constant and cooled thereafter in an exicator to ambient temperature of 25° C., prior to weighing.

The formed paper web is forced against the forming wire, to remove water, denoted as dewatering. Part of the fine particles present in the pulp suspension may flow through the wire, and are recycled back to the headbox via the short circulation. The amount of recycled fine particles defines a retention level, which describes the ability of the formed paper web to retain the fine particles on the web, and therefore the balance between drainage and formation of the paper web. The content of fine particles may be varied, for example, by selecting the pulp types and their relative shares in the pulp mixture, the wood species used for producing the pulps and by the extent of refining. An optimum retention level of the initially forming paper web enables drainage of water from the paper web such that the moisture content of the paper web may be controlled in the subsequent press and drying sections of the paper machine. The press section comprises a number of rolls for guiding and/or pressing the paper web. In the drying section, the paper web is heated to evaporate most of the remaining moisture in the paper web, thereby forming paper. After drying section, the formed paper typically has a dry content level equal to or more than 90 wt. %, for example in the range of 90 to 95 wt. %.

The finishing of the formed paper is done by surface sizing and calendering treatment. The ultimate properties of SCK paper, such as transparency and target thickness, are obtained by supercalendering, which is performed using a line pressure, heat and moisture content that are higher than conventionally used during an ordinary calendering treatment. The supercalendering of kraft paper is typically performed in a temperature in the range of 100 to 200° C. The line pressure used for supercalendering a kraft paper is generally in the range of 300 to 500 kN/m. Prior to supercalendering, the moisture content of the kraft paper may be elevated, for example by subjecting it to a spray of water or steam, such that upon supercalendering, the kraft paper has a dry content level less than 90 wt. %, such as in the range of 75 to 90 wt. %. Supercalendering enables to produce kraft paper having high density surface and high transparency. The surface of the supercalendered kraft paper is typically sized with a water-soluble polymer or a mixture of polymers in an amount ranging from 1 to 5 g/m². Examples polymers used for surface sizing are water-soluble polyvinyl alcohol, starch and carboxymethyl cellulose. The surface sizing may be used for improving the surface denseness and to enhance the barrier properties. The surface sizing may further be used for optimizing the compatibility of the surface to a subsequent release coating.

The composition of the pulp mixture upon manufacturing SCK paper may thus be used for adjusting the properties of the fiber furnish, thereby enabling formation of a paper, which may be further treated by supercalendering such that predefined properties, such as sufficient transparency and target thickness are achieved.

### BCTMP for SCK Paper

The characteristics of the BCTMP for the SCK paper production may be evaluated, for instance, based on the bulk, brightness, pH and drainability of the pulp. Advantageously the bulk of the BCTMP is equal to or higher than 1.8 cm³/g, preferably at least 2.0 cm³/g, such as in the range of 1.8 to 3.2 cm³/g, when determined according to ISO 534. Advantageously the brightness of the BCTMP is equal to or higher than 60%, preferably equal to or higher than 80%, such as in the range of 60 to 85%, when determined according to ISO 2470.

BCTMP for SCK paper, as disclosed herein, may be manufactured by a hybrid process wherein wood chips are first pretreated with chemicals, heated for a short period and subsequently refined by mechanical means. When the wood chips are pretreated in a higher pH, preferably by impregnating the wood chips with chemicals, the internal bonding of the fibers may be reduced, such that the specific volume of the formed chemithermomechanical pulp may be increased. The pH during the chemical impregnation treatment is typically above 7 and thus the treatment is alkaline. The pH environment experienced by the wood chips may be, for example in the range of pH 7 to 11, advantageously in the range of pH 7 to 9. By increasing the pH of the chemical impregnation treatment, the duration of the chemical impregnation treatment and the duration of the subsequent heating, preferably by steam, the bulkiness of the formed chemithermomechanical pulp may be increased such that less amount of refining may be required for providing the desired water retention value and fiber length distribution. When high intensity refining is used upon producing BCTMP, less energy is needed for the fibrillation of the fibers. Thus, the amount of short fibers, such as fine particles, in the BCTMP may be increased, which increases the bulk. These short fibers are beneficial for reducing the basis weight of a paper.

Typically, the BCTMP comprises fibers from hardwood, the hardwood being a broadleaved tree, such as aspen, birch, maple or eucalyptus. Maple belongs to the genus Acer. Birch belongs to the genus Betula. Eucalyptus belongs to the genus Eucalyptus, comprising species such as Eucalyptus globulus. Aspen belongs to the genus Populus, comprising species such as Populus tremuloides and Populus tremula. Aspen is considered advantageous due to low yellowing of the fibers. Aspen fibers have a large specific surface that scatter light, which increases the brightness of a paper, but may reduce transparency. BCTMP from hardwood is advantageous for increasing the bulk of the fiber furnish. Advantageously, however, the BCTMP comprises fibers from softwood, the softwood being a coniferous tree, preferably from the genus Picea, Abies, Larix or Pinus, most preferably from Picea, such as Picea abies or Pinus, such as Pinus strobus, Pinus palustris, Pinus lambertiana, Pinus taeda, Pinus monticola or Pinus poderosa. BCTMP from softwood may be used for increasing the transparency of the fiber furnish. BCTMP from softwood may further be used for increasing the strength of the fiber furnish. Advantageously, a BCTMP mixture comprising fibers from hardwood and softwood may be used to provide a pulp with balanced properties. A BCTMP mixture comprising fibers from hardwood and softwood may in particular be used to improve the manufacturing process conditions, upon producing the SCK paper. Advantageously, the share of softwood fibers in the BCTMP is in the range 10 to 60 wt. %, preferably in the range 15 to 50 wt. %, most preferably in the range of 20 to 40 wt. %, when determined as dry matter content of the BCTMP according to SCAN-P 39:80.

BCTMP comprising fibers from both hardwood and softwood may have a higher pH value than BCTMP comprising fibers from only hardwood. The presence of fibers from softwood may also be arranged to protect the hardwood fibers during mechanical refining of the BCTMP. For example, a BCTMP mixture of both aspen and spruce has been noticed to refine less than when the components are refined separately in the same conditions. The manufacturing process of BCTMP may also be improved by adjusting the pH and extent of refining, such that BCTMP having a desired water retention value and fiber length distribution is obtained.

Advantageously, the characteristics of the BCTMP are also adjusted by refining, such that upon mixing, the bleached chemithermomechanical pulp has a Schopper-Riegler number, denoted as °SR, equal to or less than 60, such as in a range from 25 to 55, preferably in the range of 30 to 55, most preferably in the range of 40 to 50, when determined according to ISO 5267-1. Refining is a mill operation wherein the pulp fibers are subjected to high shear forces. This reduces the average fiber length of the pulp fibers, but also modifies the pulp fibers physically, for example by fibrillation, such that the fiber structures become looser. The Schopper-Riegler test measures the drainability of a pulp suspension in water. Advantageously, the SCK paper has a fiber furnish, which has an average length weighted fiber length equal to or higher than 0.98 mm, preferably equal to or higher than 1.06 mm, most preferably equal to or higher than 1.11 mm, such as in the range of 0.90 to 1.14 mm, preferably in the range of 0.95 to 1.12 mm, most preferably in the range of 0.98 to 1.11 mm, when determined according to ISO 16065-2:2014. Refining of the pulp thus causes multiple effects downstream on the SCK paper manufacturing process. It produces shorter fibers which may be packed together closer, which enables to manufacture SCK paper having higher surface smoothness and surface density. However, refining also increases the moisture uptake of the pulp, which increases the amount of water to be removed from the formed paper web, in the press section and the drying section of a paper machine, which may cause dimensional changes and shrinkage of the SCK paper, and may also be seen in the paper quality, such as paper strength.

In addition to the Schopper-Riegler test disclosed above, Canadian Standard Freeness (hereafter denoted as CSF) may be used to determine the drainability of a pulp suspension, in units of millilitres (ml). Preferably, upon mixing, the bleached chemithermomechanical pulp advantageously has a Canadian Standard Freeness (hereafter denoted as CSF) value of equal to or more than of 90 ml, such as in the range of 90 to 500 ml and the pH of aqueous extracts equal to or above pH 7.0, preferably a CSF value equal to or more than 130 ml, such as in the range of 130 to 425 ml and the pH of aqueous extracts equal to or above pH 7.1, most preferably a CSF value equal to or more than 325 ml, such as in the range of 325 to 435 ml and the pH of aqueous extracts equal to or above pH 7.3. The Canadian Standard Freeness value may be determined in accordance with ISO 5267-2:2001. The pH of the pulp may be determined from aqueous pulp extracts according to ISO 6588-2(2020). The pulp pH is measured from an aqueous extract having a temperature in the range of 20 to 25° C., by means of a pH meter, using two buffer solutions having pH 4 and pH 7, respectively. Suitable pH meters are, for example, pH-meter CG 840 with electrode N 1042A, Knick pH-meter 766 Calimatic with electrode SE 103 or Mettler-Toledo MP 120, used according to the manufacturer's instructions.

The manufacturing method of BCTMP also produces fibers, which in general differ from those obtained from kraft process. Hence, the amount of BCTMP in the fiber furnish also adjusts the average fiber width. Advantageously, the SCK paper has a fiber furnish, wherein the fiber furnish has an average fiber width of equal to or less than 25 micrometers, preferably in the range of 22 to 25 micrometers, most preferably in the range of 23 to 25 micrometers, when determined according to ISO 16065-2:2014.

Advantageously, the SCK paper contains the BCTMP in an amount in the range of 5 to 50 wt. %, when determined as dry matter content of the paper according to SCAN-P 39:80. The share of BCTMP in the fiber furnish has an effect to the bulk of the uncalendered kraft paper, as well as to the bending stiffness of the supercalendered kraft paper. However, a higher BCTMP share also increases the roughness variation of SCK paper, whereby a BCTMP content in the range of 25 to 45 wt. % may be optimal, when paper smoothness is desired, in addition to bulk. When considering also the transparency of the SCK paper, a SCK paper which contains the BCTMP in an amount in the range of most preferably in the range of 30 to 40 wt. %, when determined as dry matter content of the paper according to SCAN-P 39:80, is preferred. The transparency of SCK paper, in general, is lower in paper grades, wherein the

BCTMP content is higher. However, experimental results indicate that a SCK paper having a basis weight of 68 g/m², a density of 1105 kg/m³ and which contains 15 wt. % of BSKP and 50 wt. % of BCTMP, determined as dry matter content of the paper according to SCAN-P 39:80, may have a transparency of 48%, which is sufficient for measuring brightness variation through a release liner by means of optical sensors and a light beam, such as an infrared light beam. The optimal combination of BSKP and BCTMP thus enables a production of SCK paper wherein the optical quality is maintained sufficiently such that the paper is suitable for use as a substrate layer of a release liner. Advantageously, the SCK paper has a transparency equal to or higher than 42%, preferably equal to or higher than 44%, such as in the range of 42 to 54% or in the range of 44 to 52%, determinable by standard ISO 2469.

Experimental studies further indicate that BSKP present in the fiber furnish of the SCK paper is highly advantageous for compensating the effects caused by the loss of average fiber length, due to BCTMP used to replace BHKP, as indicated above. The results indicate that when the SCK paper contains BSKP in an amount equal to or higher than 20 wt. %, when determined as dry matter content of the paper according to SCAN-P 39:80, an average length weighted fiber length equal to or higher than 1.03 mm is obtainable. When the SCK paper contains the BSKP in an amount equal to or higher than 30 wt. %, an average length weighted fiber length equal to or higher than 1.10 mm is obtainable. Advantageously, the SCK paper contains the BSKP at least 15wt. %, preferably at least 20 wt. %, most preferably at least 30 wt. %, such as in the range of 15 to 65 wt. %, preferably in the range of 20 to 60 wt. %, most preferably in the range of 30 to 55 wt. %.

### Experimental Study A1—Effect of BCTMP to SCK Paper

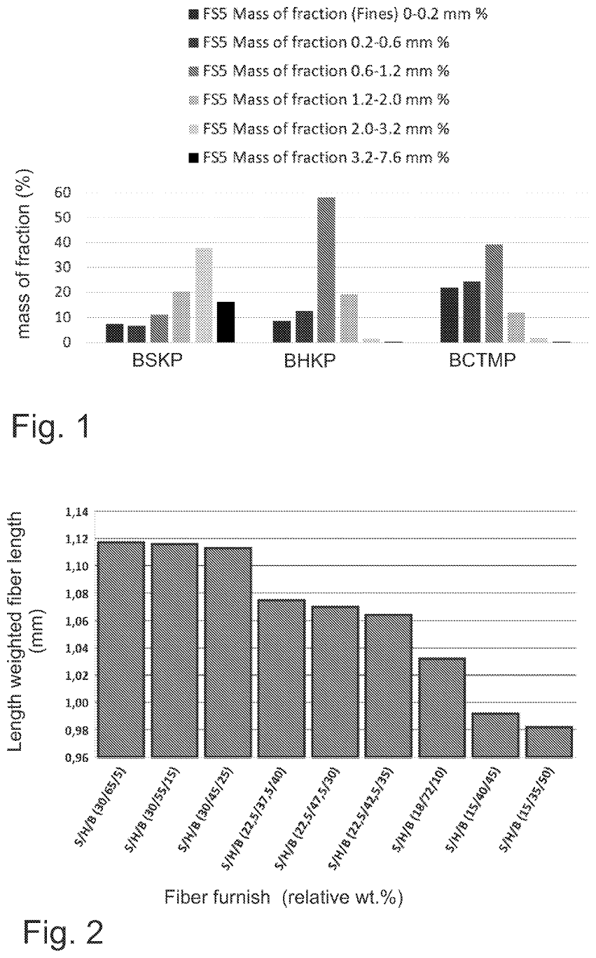

Reference is made to FIGS. 1-6. Experimental studies were carried out to characterize BCTMP, BSKP and BHKP and to assess the significance of the relative share of these pulps in a fiber furnish of SCK paper. Of particular interest was the dependency of the relevant quality characteristics of the SCK paper on the relative share of these pulps. A specific aim was to investigate how the BCTMP content adjustment of the fiber furnish composition of SCK papers having a relatively low basis weight would affect the density in selected target thicknesses and which type of adjustments would least interfere with SCK paper quality characteristics that would prevent the use of the SCK paper as substrate layer of an industrial release liner for adhesive labels.

### Experimental Setup

An experimental setup was thus designed wherein the relationship between BCTMP, BSKP and BHKP in fiber furnishes of SCK papers having a basis weight in the range of 50-70 g/m² could be studied in SCK paper specimens, wherein the fiber furnish was varied both as a function of the content of BSKP as well as a function of the content of the BCTMP.

The experimental setup contained several trial points TP1 to TP9, wherein the trial points were divided into three groups, based on whether the share of BSKP was less than 20 wt. %, equal to or higher than 20 wt. % or equal to or higher than 30 wt. %. In the first group, the content of BSKP was either 15 wt. % (TP7, TP8) or 18 wt. % (TP9). In the second group, the content of BSKP was 22.5 wt. % (TP4, TP5, TP6). In the third group the content of BSKP was 30 wt. % (TP1, TP2, TP3).

To obtain more information of the underlying dependencies, the number of data points in each trial point TP1 to TP9 was increased by producing SCK paper specimens in three different basis weight of 58, 62 and 68 g/m². Within each group, a trial point with higher BCTMP content was produced by increasing the share of BCTMP and reducing the share of BHKP, as indicated in table 1 (below). Hence, the addition of BCTMP was performed as a replacement such that the relative amount of BHKP in the fiber furnish was reduced.

TABLE 1
SCK paper specimen trial points TP1 to TP9 used in the experimental
study. The weight percentages indicate the relative share
of each pulp component in the fiber furnish.

| Trial point | BSKP (wt. %) | BHKP (wt. %) | BCTMP (wt. %) |
|---|---|---|---|
| TP1 | 30 | 65 | 5 |
| TP2 | 30 | 55 | 15 |
| TP3 | 30 | 45 | 25 |
| TP4 | 22.5 | 47.5 | 30 |
| TP5 | 22.5 | 42.5 | 35 |
| TP6 | 22.5 | 37.5 | 40 |
| TP7 | 15 | 40 | 45 |
| TP8 | 15 | 35 | 50 |
| TP9 | 18 | 72 | 10 |

SCK paper specimens for the trial points TP1 to TP9 used in the experimental study were prepared according to the ISO 5269-3 (2008) standard, using a conventional sheet-former method as described in ISO 5269-1 (2005), wherein a closed water system was used. The pulps were refined to levels typically used in SCK paper production. BCTMP refining was performed with a (Voith-Sulzer) laboratory refiner at 4% pulp consistency that corresponds well to mill refining and the °SR determined according to ISO 5267-1 (1999). The BCTMP was refined to a target °SR-value 45. The BSKP was refined to a target °SR 20-35 at a paper mill and the BHKP was refined to a target °SR 30-45 at a paper mill as well. After dewatering and drying the formed kraft paper specimens were conditioned overnight (relative humidity 90%, temperature+23° C.±2° C.). The kraft paper specimens were calendered in conditions of 100° C. roll temperature, 4000 dN pressure, using 2 passes, which produced specimens corresponding to industrial supercalendered kraft paper and having a target thickness typical for the respective basis weight.

### Example 1—Comparison of Fiber Fractions and Average Dimensions

The fiber properties were analysed from the pulps used in the SCK paper specimens as well as from the fiber furnishes by means of Valmet Fiber Image Analyzer (Valmet FS5), which is an example of a device, which can be used according to the manufacturer's instructions to perform the fiber furnish analysis. A fiber furnish analysis is capable of identifying papermaking fibers from a sample. Another example of a fiber furnish analysis is the Graff “C” stain test according to ISO 9184-4:1990(en), in conjunction with ISO 9184-1 and, if necessary, ISO 9184-2, wherein the wood species used in a pulp may be distinguished by comparison method, wherein a sample fiber is compared against a known reference fiber.

Valmet Fiber Image Analyzer (Valmet FS5) may further be used for an analysis of fiber dimensions, such as fiber length and fiber width, as well as to quantify fiber fractions, such as mass of fractions and length weighted fiber length distributions of a sample, by means of automated optical analysis using unpolarized light, according to ISO 16065-2:2014. The analysis is based on an ultra high resolution (UHD) camera system equipped with image analysis software, which is used to acquire a greyscale image of a sample, of which image the properties of the fibers in the sample may be determined. The greyscale image is acquired from a sample placed in a transparent sample holder, such as a cuvette, using a 0.5 millimetre depth of focus according to ISO 16505-2 standard.

The pulp types used in the study were characterised based on their fiber properties. Below are listed the pulp types and their abbreviation in the experimental study:

| | |
|---|---|
| BSKP | northern bleached softwood kraft pulp (Picea, Pinus) |
| BHKP | bleached hardwood kraft pulp (Betula) |
| BCTMP | bleached chemithermomechanical pulp (Populus, 75 wt. %) and |
| | spruce (Picea, 25 wt. %) |

Reference is made to FIG. 1 and Table 2 (below), which show comparative data of the determined mass of fiber length fractions of BSKP, BHKP and BCTMP.

TABLE 2
Comparative data of mass of fiber length fractions
according to fiber length in BSKP, BHKP and BCTMP.

| Fiber fraction | BSKP | BHKP | BCTMP |
|---|---|---|---|
| <0.2 mm (fines) | 7.4% | 8.7% | 22.1% |
| 0.2 < 0.6 mm | 6.5% | 12.6% | 24.5% |
| 0.6 < 1.2 mm | 11.2% | 58.2% | 39.4% |
| 1.2 < 2.0 mm | 20.7% | 19.1% | 11.9% |
| 2.0 < 3.2 mm | 37.9% | 1.4% | 1.7% |
| 3.2 < 7.6 mm | 16.2% | 0.1% | 0.4% |

The fiber mass fraction analysis was performed with Valmet Fiber Image Analyzer (Valmet FS5), using fiber length weighted distribution for classifying the fibers, according to the manufacturer's instructions and implementing ISO 16065-2:2014, ISO 9184-4 and ISO 9184-1. In the analysis,
fines were defined to be particles having a width over 10 micrometers and a length of less than 0.2 millimeters, and
fibers were defined to be particles having a width in the range of 10 to 75 micrometers and a length above 0.2 millimeters.

As demonstrated by FIG. 1 and table 2 (above), the mass fraction distribution of BCTMP sample differs considerably from the mass fraction distributions of the two BKP samples. In the BCTMP sample, the mass of the shorter fiber fractions, up to 1.2 mm in length, forms 86% of the total mass, while in BSKP, the opposite is the case. In BSKP, close to 75% of the mass is in fractions having a length equal to or higher than 1.2. mm. In comparison, in BHKP, only 20,6% of the mass is in fractions having a length equal to or higher than 1.2. mm, while in BCTMP only 14% of the mass is in fractions having a length equal to or higher than 1.2. mm. Hence, most of the mass of BCTMP is in particles having a small average fiber length.

When analysing the number of fibers in each fraction, on the other hand, it was observed that most of the fiber distribution in the BCTMP were in the shortest fractions, whereas in BSKP, the distribution was much more even, as indicated by table 3 (below).

TABLE 3
Comparative data of number of fibers in a fraction
according to fiber length in BSKP, BHKP and BCTMP.

| Fiber component | BSKP | BHKP | BCTMP |
|---|---|---|---|
| FS5 Fiber fractions (Fines) 0-0.2 mm % | 17.7% | 14.0% | 37.3% |
| FS5 Fiber fractions 0.2-0.6 mm % | 11.0% | 12.9% | 25.7% |
| FS5 Fiber fractions 0.6-1.2 mm % | 12.8% | 56.5% | 29.5% |
| FS5 Fiber fractions 1.2-2.0 mm % | 18.7% | 15.8% | 6.5% |
| FS5 Fiber fractions 2.0-3.2 mm % | 29.1% | 0.8% | 0.8% |
| FS5 Fiber fractions 3.2-7.6 mm % | 10.9% | 0.0% | 0.2% |

As an interim of the results above, the differences of the fiber analysis highlight that the origin of the pulp as well as the pulping method may be used to adjust the characteristics of the produced SCK paper.

Reference is made to FIG. 2 and to table 4 (below), which present the length weighted fiber length in millimeters determined form the SCK paper specimens (trial points TP1-TP9) in the experimental study. The diagram in FIG. 2 shows the advantageous effect of BSKP to the average fiber length in SCK paper. When the share of BSKP was 15 wt. %, the average length weighted fiber length of the fiber furnish was less than 1 mm. Further, when the SCK paper contained BSKP in an amount equal to or higher than 20 wt. %, when determined as dry matter content of the paper according to SCAN-P 39:80, an average length weighted fiber length equal to or higher than 1.03 mm is obtainable. Hence, when the share of BSKP was increased to be higher than 15 wt. %, such as equal to or higher than 20 wt. % or equal to or higher than 30 wt. %, the average length weighted fiber length of the fiber furnish increased significantly. A clear difference can be observed between the three groups in the trial. This was the case, since the increase was present within groups having a higher share of BSKP, regardless of the content of the BCTMP in the fiber furnish. The results therefore demonstrate a high dependency of the average fiber length to the content of BSKP in the fiber furnish, in SCK papers with low basis weight.

TABLE 4
Comparative data of the effect of BSKP to the average
fiber length in SCK papers with low basis weight.

| | | Length weighted |
|---|---|---|
| Trial point | Fiber furnish | fiber length (mm) |
| TP1 | S/H/B (30/65/5) | 1.12 |
| TP2 | S/H/B (30/55/15) | 1.12 |
| TP3 | S/H/B (30/45/25) | 1.11 |
| TP4 | S/H/B (22.5/47.5/30) | 1.07 |
| TP5 | S/H/B (22.5/42.5/35) | 1.06 |
| TP6 | S/H/B (22.5/37.5/40) | 1.08 |
| TP7 | S/H/B (15/40/45) | 0.99 |
| TP8 | S/H/B (15/35/50) | 0.98 |
| TP9 | S/H/B (18/72/10) | 1.03 |

### Example 2—Effect of BCTMP Content to the Bulk in the SCK Paper Specimens

To evaluate the effect of BCTMP addition in SCK papers with low basis weight, the bulk of the produced uncalendered paper sheets, in each of the trial points

TP1 to TP9, was determined. The results are presented in table 5 (below). The bulking thickness therein refers to the thickness of the uncalendered paper, determined as single sheet thickness according to ISO 534:2011. The apparent bulk density therein refers to the mass per unit volume of the uncalendered paper, which is expressed in kilograms per cubic meters (kg/m³).

The apparent bulk density has been calculated from a single sheet thickness according to ISO 534:2011. The bulk, as used therein, refers to the volume per unit mass, expressed in cubic centimeters per gram (cm³/g). The bulk therefore represents the inverse of the paper density.

TABLE 5
Comparative data of the effect of BCTMP to the bulk
of uncalendered SCK papers with low basis weight.

| | | | | Apparent | |
|---|---|---|---|---|---|
| | | Basis | Bulking | bulk | |
| Trial | | weight | thickness | density | Bulk |
| point | Fiber furnish | (g/m²) | (μm) | (kg/m³) | (cm³/g) |
| TP1 | S/H/B (30/65/5) | 57.5 | 78 | 736 | 1.36 |
| | S/H/B (30/65/5) | 60.6 | 82 | 737 | 1.36 |
| | S/H/B (30/65/5) | 67.6 | 90 | 753 | 1.33 |
| TP2 | S/H/B (30/55/15) | 58.2 | 80 | 724 | 1.38 |
| | S/H/B (30/55/15) | 62.0 | 85 | 726 | 1.38 |
| | S/H/B (30/55/15) | 68.3 | 94 | 730 | 1.37 |
| TP3 | S/H/B (30/45/25) | 58.7 | 84 | 699 | 1.43 |
| | S/H/B (30/45/25) | 62.0 | 87 | 709 | 1.41 |
| | S/H/B (30/45/25) | 68.1 | 95 | 714 | 1.40 |
| TP4 | S/H/B (22.5/47.5/30) | 58.6 | 86 | 683 | 1.46 |
| | S/H/B (22.5/47.5/30) | 62.4 | 90 | 697 | 1.44 |
| | S/H/B (22.5/47.5/30) | 68.0 | 96 | 711 | 1.41 |
| TP5 | S/H/B (22.5/42.5/35) | 57.7 | 86 | 675 | 1.48 |
| | S/H/B (22.5/42.5/35) | 62.0 | 91 | 684 | 1.46 |
| | S/H/B (22.5/42.5/35) | 68.1 | 99 | 685 | 1.46 |
| TP6 | S/H/B (22.5/37.5/40) | 58.6 | 88 | 666 | 1.50 |
| | S/H/B (22.5/37.5/40) | 62.1 | 93 | 668 | 1.50 |
| | S/H/B (22.5/37.5/40) | 68.4 | 101 | 679 | 1.47 |
| TP7 | S/H/B (15/40/45) | 58.3 | 89 | 652 | 1.53 |
| | S/H/B (15/40/45) | 62.3 | 95 | 655 | 1.53 |
| | S/H/B (15/40/45) | 68.1 | 102 | 668 | 1.50 |
| TP8 | S/H/B (15/35/50) | 58.3 | 91 | 644 | 1.55 |
| | S/H/B (15/35/50) | 62.2 | 95 | 653 | 1.53 |
| | S/H/B (15/35/50) | 68.3 | 104 | 657 | 1.52 |
| TP9 | S/H/B (18/72/10) | 58.2 | 82 | 714 | 1.40 |
| | S/H/B (18/72/10) | 62.0 | 85 | 728 | 1.37 |
| | S/H/B (18/72/10) | 67.5 | 92 | 735 | 1.36 |

The results demonstrate that the bulking thickness may be adjusted significantly as a function of the BCTMP content in the fiber furnish. The results also evidence that SCK papers with low basis weight, particularly in the range of 50-70 g/m², are exceptionally suitable for the adjustment of density with BCTMP. This was observed throughout the studied range of 5 to 50 wt. % of BCTMP additions to the fiber furnish, determined as dry matter content of the paper (SCAN P 39:80). Thus, a considerable increase of bulk was obtainable.

The obtained increase in the bulk enabled supercalendering of the paper sheets into the same thickness as corresponding SCK papers, which contain only BHKP and softwood, while maintaining a lower density than in the corresponding SCK papers, due to the obtained increase of bulk.

### Example 3—Comparison of Water Retention Value in the in SCK Paper Specimens

The SCK paper specimens in trial points TP1 to TP9 were also characterized in respect of their water retention value, abbreviated as WRV, according to ISO 23714: 2014 (en). WRV is an empirical measure of the capacity of a pulp sample to hold water. The WRV was determined as an average of two parallel samples, each sample amount consisting of 1 g of dry pulp diluted into 500 ml of water and having a temperature of 23±3° C. Materials and methods as listed below were used:
Beckman Coulter Avanti J-301 laboratory centrifuge
Centrifugal force of 3000 g±50 g, 30 minutes
JS 7,5 rotor (speed 5350; RPM 5289)

The sample was weighed first time after the centrifugation. The sample was then dried overnight (12h) at 105±2° C. and cooled down to a room temperature of 23±3° C. in an excicator. The sample was then weighed a second time. A laboratory scale (0.0001 g precision) was used for the weighing.

The water retention value was calculated according to equation 1 below:

$$W R V = \frac{m 1}{m 2} - 1 , \qquad Equation 1$$

wherein
m^{1 =}mass of sample after centrifugation, in grams
m^{2 =}mass of sample after drying, in grams.

The results in table 6 (below) indicate that when the share of BSKP in the pulp mixture is reduced to 15 wt. % of the fiber furnish, while keeping the share of BCTMP high, a drop in the WRV is perceived. Hence, upon manufacturing SCK paper for a release liner, a minimum amount of BSKP equal to or higher than 15 wt. % should be used, to prevent fluctuation of the WRV level. Further, when the amount of BSKP in the fiber furnish is above the minimum amount, the amount BCTMP content may be varied significantly, in the range of 5 to 5 0wt. %, without corresponding alteration in the capacity of the pulp mixture to hold water. Thus, when producing SCK paper, an optimum range exists, wherein the amount of BSKP may be arranged to interact with the amount of BCTMP in the fiber furnish. When studying the WRV of the unmixed pulps used for the fiber furnish, it was observed that WRV of the BSKP was the highest, 1.84 g/g. The WRV of BHKP was 1.60 g/g, which was on a comparable level with the BCTMP, having a WRV of 1.58 g/g.

TABLE 6
Comparative data of water retention values in SCK paper
specimens of the experimental study, wherein the relative
share of BSKP, BHKP and BCTMP was varied.

| Sample | Fiber furnish | WRV (g/g) |
|---|---|---|
| TP1 | S/H/B (30/65/5) | 1.65 |
| TP2 | S/H/B (30/55/15) | 1.69 |
| TP3 | S/H/B (30/45/25) | 1.66 |
| TP4 | S/H/B (22.5/47.5/30) | 1.65 |
| TP5 | S/H/B (22.5/42.5/35) | 1.67 |
| TP6 | S/H/B (22.5/37.5/40) | 1.67 |
| TP7 | S/H/B (15/40/45) | 1.63 |
| TP8 | S/H/B (15/35/50) | 1.62 |
| TP9 | S/H/B (18/72/10) | 1.67 |

Thus, by adjusting the fiber furnish of the SCK paper with BCTMP, a WRV equal to or higher than 1.58 g/g, preferably equal to or higher than 1.60 g/g, may be obtained. A fiber furnish containing BCTMP in the range of 5 to 50 wt. % may be used to provide a pulp composition having WRV, which is in the range of 1.50 to 1.90 g/g, preferably in the range of 1.54 to 1.88 g/g, most preferably in the range of 1.58 to 1.84 g/g, from a sample having a dry matter content of 1 gram (ISO 23714:2014).

### Example 4—Effect of BCTMP and BSKP Combination for SCK Paper Quality Criteria

To study the combined effect of BSKP and BCTMP in the fiber furnish in respect of the quality specifications for SCK papers, the uncalendered papers, as disclosed above, were supercalendered, using target thicknesses in the range of 51 to 61 micrometers, which are typical for SCK papers in the range of 58 to 68 g/m². Paper specimens having a basis weight of 58 g/m² were supercalendered into a thickness in the range of 51 to 53 micrometers. Paper specimens having a basis weight of 62 g/m² were supercalendered into a thickness in the range of 52 to 56 micrometers. Paper specimens having a basis weight of 68 g/m² were supercalendered into a thickness in the range of 57 to 61 micrometers. The average density of the prepared supercalendered kraft paper specimens was 1127±17 kg/m³, the latter number indicating the standard deviation.

Tensile, bending and tear strength properties, as well as optical properties of the prepared SCK paper specimens were determined to evaluate the suitability of the produced SCK paper for use as a substrate layer of an industrial release liner. Tensile index refers to the tensile strength divided by the basis weight, determinable according to standard ISO 1924-3:2005(en), in units of Newton meter per gram. Tensile index is indicative of the strength of the paper derived from factors such as fiber strength, fiber length, and bonding. It can also be used as an indication of the potential of a paper substrate to resist web breaking during a labelling operation. Bending stiffness refers to the potential of a paper to resist bending caused by a given applied force and is determinable according to standard ISO 5628:2019(en), in units of milliNewton meters (mNm). Bending stiffness has been observed to be also indicative of the compressibility of the paper and may thus be used to assess the potential of a paper to resist compression, for instance upon a die-cutting operation, if the paper is used as a substrate layer of a release liner for adhesive labels. Tear index refers to the tearing strength of a paper divided by its basis weight, determinable according to ISO 1974, and is expressed in units of milliNewtons divided by grams per square meters (mNm²/g). Tear index is indicative of the resistance of a paper to a tearing force that it is subjected to, which is a quality characteristic for a paper used as a substrate layer of an industrial release liner. It can be measured in machine direction (MD) or cross direction (CD) of a paper, the machine direction referring to the travelling direction of the paper on a paper machine. Table 7 (below) indicates the results of the strength and optical properties determined from the prepared supercalendered kraft paper specimens.

TABLE 7
Results concerning the density, strength and optical properties of the prepared
SCK paper specimens in trial points TP1 to TP9.

| | | basis | | Tensile | Bending | Tear | |
|---|---|---|---|---|---|---|---|
| Trial | | weight | density | index | stiffness | index | Transp. |
| point | Fiber furnish | (g/m²) | (kg/m³) | (Nm/g) | (mNm) | (mNm²/g) | (%) |
| TP1 | S/H/B (30/65/5) | 58 | 1142 | 84 | 1.0 | 6.4 | 52 |
| | S/H/B (30/65/5) | 62 | 1151 | 82 | 1.1 | 6.7 | 51 |
| | S/H/B (30/65/5) | 68 | 1165 | 79 | 1.5 | 7.0 | 49 |
| TP2 | S/H/B (30/55/15) | 58 | 1136 | 76 | 0.9 | 6.3 | 51 |
| | S/H/B (30/55/15) | 62 | 1137 | 77 | 1.2 | 6.7 | 49 |
| | S/H/B (30/55/15) | 68 | 1146 | 79 | 1.5 | 6.8 | 48 |
| TP3 | S/H/B (30/45/25) | 58 | 1128 | 72 | 0.9 | 6.1 | 50 |
| | S/H/B (30/45/25) | 62 | 1134 | 72 | 1.1 | 6.3 | 50 |
| | S/H/B (30/45/25) | 68 | 1141 | 75 | 1.4 | 6.5 | 49 |
| TP4 | S/H/B (22.5/47.5/30) | 58 | 1134 | 72 | 1.0 | 6.2 | 49 |
| | S/H/B (22.5/47.5/30) | 62 | 1134 | 71 | 1.2 | 6.1 | 49 |
| | S/H/B (22.5/47.5/30) | 68 | 1144 | 69 | 1.5 | 6.3 | 48 |
| TP5 | S/H/B (22.5/42.5/35) | 58 | 1112 | 68 | 1.0 | 5.6 | 51 |
| | S/H/B (22.5/42.5/35) | 62 | 1112 | 70 | 1.2 | 5.9 | 48 |
| | S/H/B (22.5/42.5/35) | 68 | 1116 | 69 | 1.5 | 6.0 | 47 |
| TP6 | S/H/B (22.5/37.5/40) | 58 | 1097 | 65 | 1.0 | 5.7 | 48 |
| | S/H/B (22.5/37.5/40) | 62 | 1112 | 69 | 1.2 | 5.6 | 50 |
| | S/H/B (22.5/37.5/40) | 68 | 1126 | 67 | 1.4 | 5.9 | 47 |
| TP7 | S/H/B (15/40/45) | 58 | 1099 | 62 | 1.0 | 5.4 | 47 |
| | S/H/B (15/40/45) | 62 | 1111 | 66 | 1.2 | 5.6 | 46 |
| | S/H/B (15/40/45) | 68 | 1114 | 66 | 1.5 | 5.9 | 45 |
| TP8 | S/H/B (15/35/50) | 58 | 1105 | 63 | 1.0 | 5.3 | 48 |
| | S/H/B (15/35/50) | 62 | 1108 | 62 | 1.1 | 5.4 | 47 |
| | S/H/B (15/35/50) | 68 | 1116 | 62 | 1.5 | 5.5 | 46 |
| TP9 | S/H/B (18/72/10) | 58 | 1131 | 75 | 0.9 | 6.3 | 51 |
| | S/H/B (18/72/10) | 62 | 1145 | 76 | 1.2 | 6.5 | 50 |
| | S/H/B (18/72/10) | 68 | 1146 | 79 | 1.4 | 6.6 | 49 |

In each trial point, paper specimens were produced into three different basis weight of 58, 62 and 68 g/m².
When considered together, the value ranges determined from the SCK paper specimens for density, tensile index, bending stiffness, tear index, as well as transparency indicate suitability for use as a substrate layer of a release liner.

When reviewing the results of table 7 above, moderate decrease can be seen in the tensile index and tear index levels in the trial points TP1 to TP9, as the amount of BCTMP in the fiber furnish is increased. However, even when the amount of BHKP in the fiber furnish was reduced significantly by means of BCTMP replacement from 72 wt. % in TP9 to 35 wt. % in TP8, a paper having sufficient strength characteristics for a substrate layer of a release liner could still be obtained, presenting a tear index higher than 5 mNm²/g and a tensile index higher than 60 Nm/g. A relatively high and sufficient transparency could also be obtained, regardless of the basis weight produced, at a desired target thickness level, which enables the use of optical sensors to measure brightness variation. In particular, as indicated by the results above, the bending stiffness was also maintained and even slightly increases as a function of BCTMP content in the fiber furnish, when the SCK paper contains BCTMP in an amount in the range of 5 to 50 wt. % and BSKP in an amount equal to or higher than 15 wt. %, when determined as dry matter content of the paper according to SCAN P 39:80. Thus, the substitution of BHKP with BCTMP enables to maintain incompressibility of the SCK paper. The results indicate that a tailored fiber furnish, wherein the amount of BCTMP and BSKP have been optimized, may be arranged to provide SCK paper with both lower density, relatively high transparency and potential to resist compression, which facilitates an even die strike pattern during a die-cutting operation-while maintaining the tear index and tensile strength at a sufficient level for use as a substrate layer for a release liner.

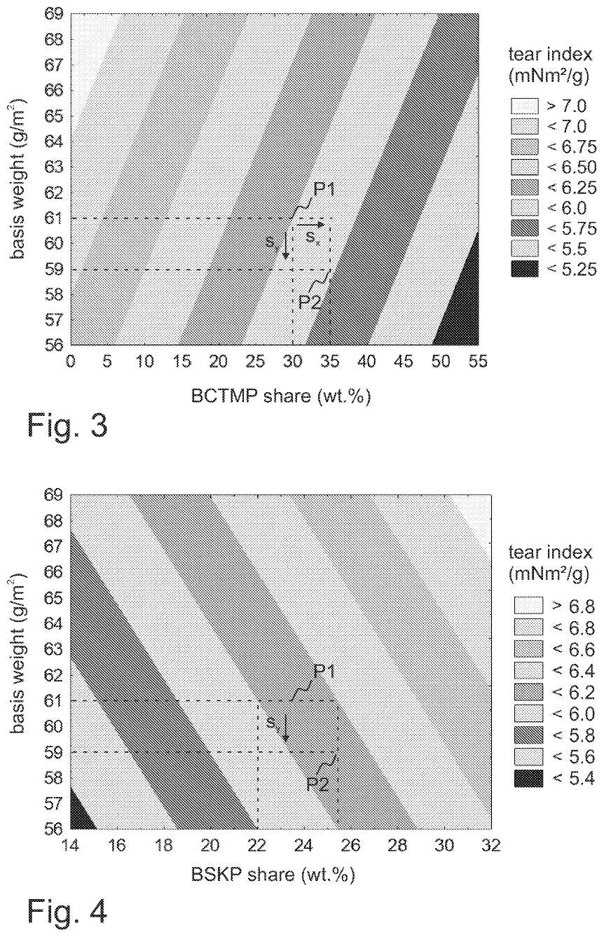

The dependency of basis weight, fiber furnish composition and paper characteristics of each other was further studied by means of multivariable optimization, as illustrated by FIGS. 3 to 5. The figures illustrate, when viewed together, by way of the examples, how mechanical and optical properties of the produced SCK paper are maintained, when the basis weight of the paper is shifted and/or when the composition of the fiber furnish is altered by adjusting the amount of BCTMP and/or BSKP in the fiber furnish—while maintaining the target thickness of the SCK paper. The symbols P1 and P2 in the figures illustrate SCK papers having the same target thickness, but a different basis weight and, subsequently, different densities.

Reference is made to FIG. 3, which is a multivariable diagram based on the experimental results, and which illustrates how basis weight correlates with the tear index, as a function of BCTMP content in a SCK paper having a defined target thickness, as disclosed below. The vertical axis represents the basis weight (g/m²) of the SCK paper, determined according to ISO 536. The horizontal axis represents the amount of BCTMP (wt. %) in the fiber furnish, determined as dry matter content of the paper according to SCAN P 39:80. The shading of the inclined bars in the diagram represents the range of tear index (mNm²/g), determined according to ISO 1974. The inclination angle of the bars in the diagram is indicative of the direction of change of the tear index. When moving from top left corner towards the bottom right corner in the diagram, the tear index decreases.

Reference is further made to FIG. 4, which is a multivariable diagram based on the experimental results, and which illustrates how basis weight correlates with the tear index, as a function of BSKP content in a SCK paper having the same defined target thickness, as disclosed below. The vertical axis represents the basis weight (g/m²) of the SCK paper, determined according to ISO 536. The horizontal axis represents the amount of BSKP (wt. %) in the fiber furnish, determined as dry matter content of the paper according to SCAN P 39:80. The shading of the inclined bars in the diagram represents the range of tear index (mNm²/g), determined according to ISO 1974. The inclination angle of the bars in the diagram is indicative of the direction of change of the tear index. When moving from bottom left corner towards the top right corner in the diagram, the tear index increases.

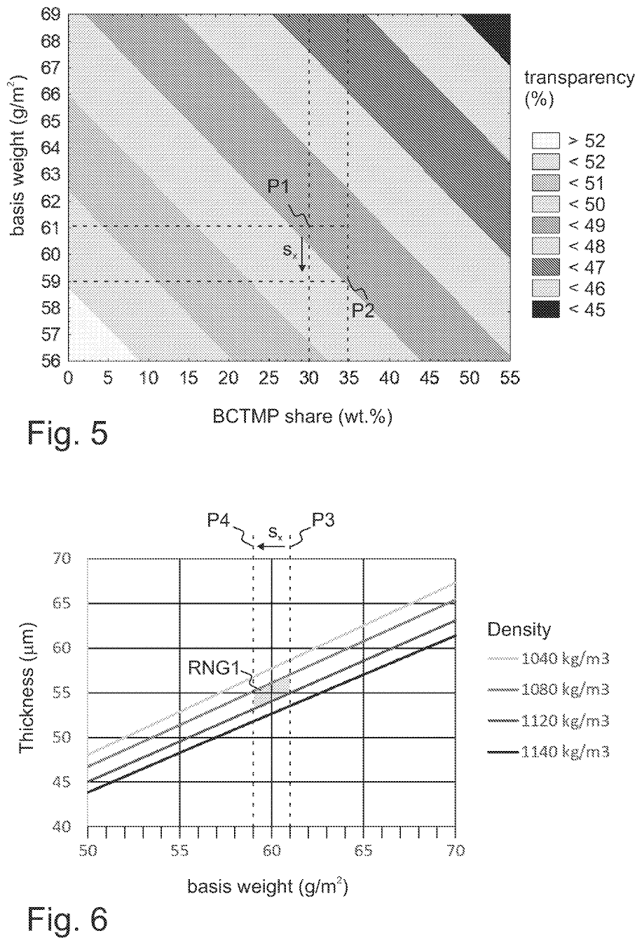

Reference is further made to FIG. 5, which is a multivariable diagram based on the experimental results, and which illustrates how basis weight correlates with the transparency, as a function of BCTMP content in a SCK paper having the same defined target thickness, as disclosed below. The vertical axis represents the basis weight (g/m²) of the SCK paper, determined according to ISO 536. The horizontal axis represents the amount of BCTMP (wt. %) in the fiber furnish, determined as dry matter content of the paper according to SCAN P 39:80. The shading of the inclined bars in the diagram represents the transparency range (%), determined according to ISO 2469. The inclination angle of the bars in the diagram is indicative of the direction of change of the transparency. When moving from bottom left corner towards the top right corner in the diagram, the transparency decreases.

FIGS. 3 and 4, when viewed together, demonstrate the interdependency of the shares of BCTMP and BSKP in the fiber furnish to the tear index of the SCK paper. This is illustrated by a situation, wherein the basis weight is shifted by 2 g/m² in a direction sy by means of adjusting the share of BCTMP in the fiber furnish by 5 wt. % in a direction sₓ, as indicated in FIG. 3 with the dashed lines. Paper P1 represents a SCK paper having a basis weight of 61 g/m² and a target thickness of 53.5 micrometers, thus having a density of 1140 kg/m³. Paper P2 represents a SCK paper having a basis weight of 59 g/m² and the same target thickness of 53.5 micrometers, thus having a density of ca.1100 kg/m³. When the basis weight is decreased by 2 g/m², while maintaining the same target thickness, the density of the SCK paper P2 is subsequently reduced close to 40 kg/m³, in comparison to the heavier SCK paper P1. Multivariable diagrams, such as presented by FIGS. 3 and 4, provide a tool that enables to evaluate the effect of this shift of basis weight, which has been achieved due to the change in the amount of BCTMP, in light of other parameters, such as the tear index of the SCK paper. For instance, the diagrams in FIGS. 3 and 4 indicate, that a relative change of 5 wt. % of BCTMP from 30 to 35 wt. % (indicated by distance between the vertical dashed lines in FIG. 3) may be performed while maintaining a tear index equal to or higher than 6 mNm²/g (indicated by the shade of the inclined bar in FIGS. 3 and 4), when the share of BSKP in the fiber furnish is maintained sufficiently high, such as at least 22 wt. % (leftmost vertical dashed line in FIG. 4). The breadth and inclination angle of the shaded bar in FIG. 4 suggest of the potential of the BSKP to preserve the tear index, when replacing BHKP with BCTMP. When shifting from the basis weight of the SCK paper P1 to the basis weight of the SCK paper P2, a BSKP share in the range of 22 to 25.5wt. % may be used, if a tear index in the range of 6 to 6.4 mNm²/g should be achieved. Further information may be retrieved from other multivariable diagrams, such as FIG. 5, which is indicative of the effect of the same shift of basis weight to the transparency of the SCK paper. FIG. 5 also illustrates that when a relative change of 5 wt. % of BCTMP from 30 to 35 wt. % is performed to the fiber furnish, while maintaining the same target thickness by supercalendering, the fiber furnish combination enables the transparency to be maintained in a relatively high level in the range of 47 to 51% (the shades covered between the vertical dashed lines in FIG. 5). On the other hand, when the basis weight is decreased by 2 g/m² (the horizontal dashed lines in FIG. 5), while maintaining other variables unchanged, a relatively small decrease to transparency may occur, the transparency still being in the range of 48 to 50% (indicated by the shades covered between the horizontal and vertical dashed lines in FIG. 5).

Thus, referring to the above, the experimental results indicate the pliability of the SCK paper in a basis weight range of 50-70 g/m², when the underlying properties of the different type of pulps, BSKP and BCTMP in particular, are used together optimally. This enables a fiber furnish containing BCTMP in the range of 5 to 50 wt. %, when determined as dry matter content of the paper according to SCAN P 39:80, which may be supercalendered into the same thickness as a similar kraft paper with a higher basis weight, while maintaining a transparency level of at least 40%, such as in the range of 40 to 56%. Thus a significant reduction of the basis weight is obtainable, while maintaining a predefined thickness specification and without other relevant quality characteristics falling out of the SCK paper specifications.

Reference is further made to FIG. 6, which illustrates how the characteristics of SCK paper having a basis weight in the range of 50 to 70 g/m² provide an optimization range RNG1, wherein the basis weight of the SCK paper to be produced may be adjusted by means of fiber furnish composition as disclosed above. The vertical axis represents the thickness in micrometers (μm) of the SCK paper, determined as single sheet thickness of a paper according to ISO 534:2011. The horizontal axis represents the basis weight in grams per square meters (g/m²) of the SCK paper, determined according to ISO 536. The parallel diagonal lines in the diagram represents different density levels of the SCK paper, the density levels expressed in kilograms per cubic meter (kg/m³). The angle of inclination of the lines in the diagram is indicative of the typical correlation strength between basis weight and thickness in industrial SCK papers in the range of 50 to 70 g/m². When moving along a diagonal lines from bottom left corner towards the top right corner in the diagram, the density remains the same, while the basis weight and the thickness increase.

In FIG. 6, paper P3 represents SCK paper having a basis weight of 61 g/m² and a target thickness of 55 micrometers, thus having a density of 1120 kg/m³. Paper P4 represents SCK paper having a basis weight of 59 g/m² and the same target thickness of 55 micrometers, thus having a density of 1080 kg/m³. The shaded area represents an optimization range RNG1, wherein the multivariable diagrams discussed above need to be accounted for.

Hence, when starting from SCK paper P3 and desiring a reduction of 2 g/m² of the basis weight (the distance between the vertical dashed lines indicated in FIG. 6), the multivariable diagrams provide a tool for evaluating the means for obtaining a SCK paper P4 having the same thickness and sufficient quality for the intended purpose (as illustrated by FIGS. 3 and 5). To maintain the sufficient quality, the amount of BCTMP in the fiber furnish needs to be considered in light of the amount of BSKP in the fiber furnish.

### Recycled Pulp Obtained from RSCK

RSCK is exceptional material, when considering it from a viewpoint of circular economy. When producing supercalendered Kraft paper from non-recycled BCP the fibers experience very harsh conditions. At a paper machine, the delignified hardwood and/or softwood fibers in the bleached chemical pulp undergo repeated drying and wetting cycles in the presence of chemicals, relatively high temperatures and high pressure. These treatments cause irreversible changes to the fiber structure, in particular to the pores formed between the cellulose protofibrils. This leads to reduced swelling capability of the fibers. The morphology as well as the ability of the fibres to swell is different, when compared to other type of fibers, such as, for instance, fibers from non-recycled bleached chemical pulp or broke. The phenomenon is specific for chemically pulped fibers. Due to this phenomenon, referred to as hornification, fibers derived from supercalendered Kraft paper display less bonding ability. Upon producing a release liner, the fibers are coated with a hydrophobic silicone polymer and heated, which exposes the fibers to further modifications.

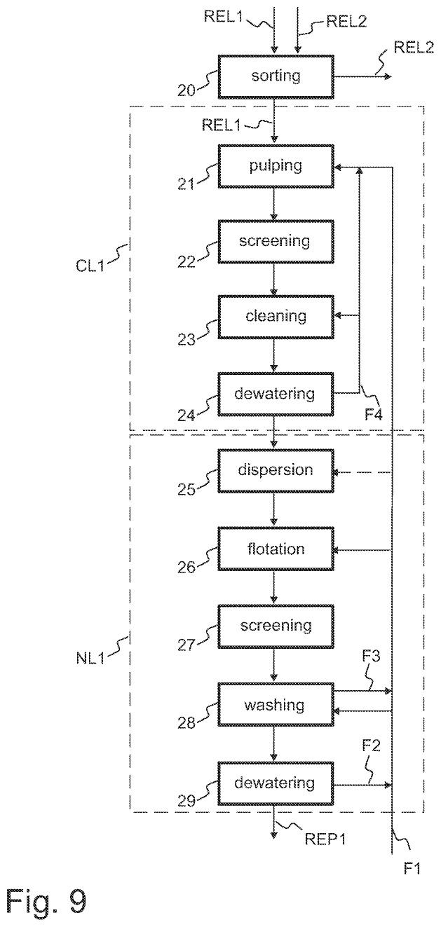

Reference is made to FIG. 9. Release liner supercalendered Kraft papers share a common history of treatments. This enables to use RSCK as raw material in a recycling process, which may be arranged to produce pulp with exceptional characteristics. To obtain sufficient quality recycled pulp for a method for manufacturing supercalendered Kraft paper, the raw material used for the recycling process should contain at least 75 wt. %, more preferably at least 85 wt. %, most preferably at least 90 wt. % of release liner supercalendered Kraft paper. Advantageously the raw material used for the recycling process consists substantially of release liner supercalendered Kraft paper. A method for manufacturing recycled pulp from a release liner supercalendered Kraft paper therefore contains a step for sorting RSCK for recycling.

A method for manufacturing recycled pulp from a release liner supercalendered Kraft paper comprises a sorting stage 20 for separating RSCK apart from other papers, a first process stage, denoted as a caustic loop CL1, having a principal function of disintegrating the RSCK into pulp and detaching non-fiber material from fibers, and a second process stage, denoted as a cleaning loop NL1, having a principal function of separating pulp fibers from non-fiber material, in particular silicone particles originating from the release coating. Caustic loop CL1 provides conditions in which the pulp fibers are able to swell and fibrillate. Cured silicon-based organic polymers, polydimethylsiloxanes in particular, are generally water-resistant and relatively inert chemically. Hence, in RSCK recycling conditions, as disclosed herein, the release coating is typically fragmented into pieces, which are hereafter denoted as silicone-based particles. In addition to the principal functions, the caustic loop CL1 and the cleaning loop NL1 are configured to adjust the fibrillation of the pulp suspension, such that the recycled pulp obtained from the release liner supercalendered Kraft paper REP1 has a pulp drainability in a range which enables the use of the recycled pulp obtained from the RSCK in a method for manufacturing supercalendered Kraft paper without further refining. The caustic loop CL1 and cleaning loop NL1 provide means to control the chemical load and temperature of the recycling process, as well as a means to adjust the consistency of the suspension.

Due to industrial use in high-speed labelling processes, RSCK may be collected in large quantities directly from an industrial user. Therefore, advantageously, the sorting of the RSCK takes place at a site where release liner REL1, REL2 is used and converted into recyclable release liner waste, for example during a labelling process. For example, polyethylene coated Kraft papers can at this point be separated and excluded from recycling. Unlike water-soluble polymers or mineral coatings, a polyethylene film does not dissolve into the suspension and is therefore challenging to recycle. Alternatively, the sorting can be performed later at a sorting unit, for instance by using visual inspection, such that release liner supercalendered Kraft paper REL1 is separated from other paper components REL2 and non-paper components. The non-paper components, to the extent possible, are rejected already prior to entering a RSCK recycling process. A non-paper component refers to an object which has typically become unintentionally part of a paper recycling process due to material handling. A non-paper component is not adhered to paper and is meant to be rejected during the recycling process. Examples of non-paper components are plastic and films components, as well as pieces of metal, glass or sand.

Sorted RSCK may be further separated based on a color shade of the paper. For example, light RSCK shades, such as white and yellow shades, may be separated from other shades. Advantageously, white RSCK grades, wherein the paper furnish does not contain colorants, are separated apart from non-white RSCK grades, such as yellow RSCK grades. A CIELAB color space may be used for measuring the colour of the RSCK and for rejecting non-light or non-white RSCK grades. A white supercalendered Kraft paper, in this context, refers to CIE L*, a*, b* colour space coordinate values of the paper, wherein
L* is in the range of 92 to 98,
a* is in the range of −4 to +2, and
b* is in the range of +5 to +11,,
the values measured from a paper sample by means of diffuse reflectance method with the elimination of specular gloss, using standard illuminant D65 and 10° standard observer, in accordance with ISO 11475:2017(en). An advantage of sorting the RSCK based on a color shade of the paper is that recycled pulp obtained from RSCK may be produced without bleaching. Thus, a supercalendered Kraft paper suitable for use as a substrate of a release liner may comprise fibers from non-recycled bleached chemical pulp produced from hardwood and softwood, as well as recycled pulp obtained from supercalendered Kraft paper that has been used as a substrate of a release liner, which recycled pulp has not been bleached.

Alternatively, or in addition, the sorting can be performed mechanically, for example by using automated image analysis. An automated image analysis system may comprise, for example, a detection unit, a control unit, and sorting unit arranged to detect and separate RSCK apart from other paper products and non-paper products, based on particle shape, size and contrast. A detection unit may comprise optical instruments capable of identifying wavelengths of the visible light spectrum for detecting and identifying the colour of the paper. This may be complemented by instruments capable of identifying near infrared light, which are able to provide further information of the nature of the materials in the paper. The automated image analysis may be configured to assess paper quality based on multiple parameters, such as paper whiteness, brightness, colour shade, transparency or contrast. Pressurized air and nozzles operating on a conveyer belt may be used to separate rejected material and accepted material Advantageously, the material, after sorting, contains RSCK in the range of 75-100 wt. %, preferably in the range of 85-100 wt. %, most preferably in the range of 90-100 wt. % of the weight of the recyclable paper components. In an ideal case, the material sorted for recycling consists substantially of RSCK.

The caustic loop CL1 comprises a high consistency pulping unit 21, a screening unit 22, a cleaning unit 23 and a dewatering unit 24. The high consistency pulping unit 21 is arranged to operate in a batch mode, which facilitates the adjustment of the pulping conditions. When RSCK and clear water F1 are fed to a high consistency pulper, a pulp suspension is formed. The consistency of the pulp suspension may be adjusted by the amount of clear water F1, which may be obtained from another process. The clear water F1 may be fresh water. The consistency of the pulp suspension may be further adjusted by reusing process water F2, F3, F4 downstream from the recycling process, as needed. Process water circulated within a loop CL1, NL1 may be further used to improve the recovery of fibers within the loop CL1, NL1. For efficient disintegration of the RSCK, the consistency of the material during the pulping may be higher than 15 wt. %, preferably higher than 18 wt. %, such as in the range of 20 to 30 wt. %, advantageously in the range of 20 to 25 wt. %.

The pulping of RSCK is performed in alkaline conditions to facilitate disintegration of the cellulose fibers from the RSCK, since RSCK comprises a dense surface, a polymeric primer coating and a release coating. Advantageously, during pulping, the pH is maintained in a range between 8.5 to 10. The pH may be adjusted by addition of NaOH, referred to as caustic soda. Caustic soda reacts with the hydrogen groups of the fiber and promotes fiber swelling, referred to as caustic swelling, which will loosen the fiber network of the RSCK. Caustic soda also acts as an activator for hydrogen peroxide, which may be used to facilitate oxidative bleaching, when the pulp suspension contains colourants, for example blue colorant from a non-white grade of paper. Hydrogen peroxide is also used to prevent yellowing during the pulping. Typically, hydrogen peroxide is added in the range of 0.5-2 wt. %. Sodium silicate is typically added to buffer the pH of the pulp suspension and to prevent the pH of the suspension from rising excessively at the beginning of pulping. Sodium silicate thus contributes to the alkalinity of the pulp suspension, such that the conditions are suitable for the caustic swelling. Sodium silicate may be also used as a stabilising agent for the hydrogen peroxide. Sodium silicate may further improve the detachment of release liner from the fibers. Typically, sodium silicate is added in the range of 1-6 wt. %. In addition to sodium silicate, a saponifying agent, typically a fatty acid such as palmitic acid or stearic acid, is used for facilitating the detachment of silicone-based particles and other hydrophobic impurities from the fibers. Fatty acids react first with caustic soda and then with calcium ions present in the pulp suspension and form calcium soap, which is water-insoluble and finely dispersed in an aqueous phase. Soap particles, which are strongly hydrophobic, facilitate maintaining the pulped fibers and the detached hydrophobic particles, such as silicone-based particles, apart from each other in the pulp suspension. Typically, a fatty acid is used in a range of 0.1 to 1.5 wt. % of the RSCK. The fatty acid dose is advantageously matched with the water hardness, such that the amount of fatty acids is substantially equal with the amount of calcium ions present in the suspension.

Depending on the HC pulper type, the operating time of the pulping may be adjusted. The total operating time, referred to as slushing or dwell time, is generally in the range of 30 to 60 minutes, preferably at least 40 minutes, to ensure sufficient disintegration of the cellulose fibers. Typically, the temperature of a pulp suspension during pulping is at least 60° C., preferably at least 75° C., such as in the range of 60-85° C. The primer coating of the RSCK typically comprises water-soluble polymers, such as partially or fully hydrolysed polyvinyl alcohol, carboxymethyl cellulose and/or starch, which have a tendency to agglomerate at elevated temperature. While at least some of the water-soluble polymers may be dissolved during the pulping and hence filtered out during the subsequent dewatering operations, a higher pulp suspension temperature, preferably at least 75° C., promotes the agglomeration of any non-dissolved water-soluble polymers detached from the fibers. Agglomerated polymer particles from the sizing agents or release coating are easier to remove in subsequent screening and cleaning operations.

Thus, a high consistency suspension, sufficient time, temperature and chemical additives, such as hydrogen peroxide, sodium silicate (water glass) and caustic soda (NaOH), may be used to disintegrate and detach the fibers of the RSCK and induce caustic swelling, despite the hornification of the fibers.

A coarse screening unit 22, such as a disc screen having aperture size equal to or less than 4 millimeters, such as in the range of 2 to 4 millimeters, preferably in the range of 2.0 to 3.0 millimeters, most preferably in the range of 2.2 to 2.5 millimeters, is used to separate particles coming from the pulper based on their size, form and shape. The screening operates under pressure and particles passing through the aperture are accepted, while others are rejected. This enables to remove solid contaminants and non-paper components from the pulp suspension, such as sand and metal objects, as well as larger particle agglomerates.

A high-consistency cleaning unit 23, such as a cleaner using centrifugal field, is used to complement the coarse screening to separate pulp fibers from contaminants based on specific gravity. A centrifugal cleaner can remove particles down to a dimension of 10 micrometers. In addition to heavy particles such as sand and metal, a centrifugal cleaner can separate also light-weight particles present in the RSCK, such as polymer particles, release coating agglomerates or residual adhesive stickies, when their density differs sufficiently from the density of water. PVA, for example, has a density typically in the range of 1.19-1.35 g/cm³ at 25° C., which differs significantly from the density of water. The separation of particles having a density closer to 1.00 g/cm³, may be improved by raising the pulp suspension temperature, which decreases the density of the water. The pulp suspension temperature during the high-consistency cleaning is typically in the range of 30 to 85° C., preferably in the range of 50 to 85° C., to facilitate the cleaning of the PVA. When using a high-consistency cleaner, in general, a pulp consistency of 2-6 wt. % is used. The consistency of the pulp suspension during the cleaning may be adjusted by means of adjusting the pulping and screening conditions. The consistency of the pulp suspension may be further adjusted by reusing process water F4 downstream from the recycling process, as needed.

A dewatering unit 24 based on pressing or filtration is used to mechanically remove process water F4 from the pulp suspension and to increase the pulp consistency. Dewatering thus separates solids from a suspension. Preferably, a disk filter, a screw press or a twin-wire press is used, for efficient loop separation between the caustic loop CL1 and the cleaning loop NL1. A high consistency enables an efficient dispersion in the cleaning loop NL1, which can be used to adjust the pulp fibrillation and drainability. An efficient solid removal further enables to remove dissolved sizing agents which have not been screened or cleaned out from the pulp suspension. The pressing of the pulp suspension at the dewatering unit 24 results into a thickened pulp suspension, which comprises the fibers to be retained. Advantageously, at the end of the caustic loop CL1, the pulp suspension is thickened into a consistency equal to or higher than 20 wt. %, such as in the range of 20 to 50 wt. %, preferably in the range of 25 to 40 wt. %.

The cleaning loop NL1 comprises a dispersion unit 25, a flotation unit 26, a second screening unit 27, a washing unit 28 and a dewatering unit 29. A dispersion unit is used for producing shear forces which are sufficient for detaching remaining contaminants, such as silicone-based polymer, from the fibers and to adjust the average size of the contaminant particles to below 100 micrometers, suitable for removal by means of flotation. The dispersion unit may operate with a thickened pulp suspension received directly from the dewatering unit. The method may further comprise a dilution chest prior to the dispersion unit, for adjusting the consistency and/or temperature of the dewatered pulp suspension. Clear water F1 and/or process water F2, F3 downstream from the recycling process may be used to adjust the consistency of the dewatered pulp suspension. The process water F2, F3 downstream from the recycling process may further be used to adjust the pH of the dewatered pulp suspension. Consistency of the dewatered pulp suspension provides a means for adjusting the amount of dispersion energy applied to the pulp suspension. Advantageously, the dispersion is performed with a conical or disc disperger instead of a kneader. Unlike a kneader, a conical disperger and a disc disperger operate in conditions similar to refining. This enables an efficient and simultaneous adjustment of pulp fiber properties such that at least some of the fiber properties of RSCK fibers lost due to hornification may be compensated already during the RSCK recycling process. Thereby the recycled pulp characteristics, such as drainage and bulk, may be optimized for a method for manufacturing supercalendered Kraft paper. Conical and disc type dispergers operate in a manner where inverse correlation between pulp fibrillation and temperature exists; a lower pulp suspension temperature at the inlet correlates with a higher decrease in fibrillation. Typically, when a pulp suspension having a consistency in the range of 25 to 40 wt. % is used, the temperature of the pulp suspension at the inlet to the disperger is in the is range of 50 to 130° C., preferably in the range of 50 to 85° C. Thus, the fibrillation and drainability of the pulp can be adjusted during the dispersion by means of controlling the pulp consistency and temperature, in addition to the amount of specific energy consumed (SEC). In general, SEC in the range of 30-150 kWh/t, preferably in the range of 40-100 kWh/t, most preferably in the range of 45-90 kWh/t, may be used during the dispersion, to obtain pulp having a SR number equal to or higher than 25, such as in a range from 30 to 55, when determined according to ISO 5267-1.

A flotation unit 26 is used to remove hydrophobic particles from the pulp suspension by means of air bubbles, which collide and adhere to the particles. Clear water F1 and/or process water F2, F3 downstream from the recycling process is used for adjusting the consistency of the pulp suspension for flotation. Typically, a pulp suspension having a consistency less than 2 wt. %, such as in the range of 0.5 to 1.5 wt. %, is used for the flotation. The pulp suspension temperature during the flotation is typically in the range of 40 to 70° C. Advantageously, during flotation, the pH is maintained alkaline, in a range between 7 to 10, preferably equal to or higher than 8.5, such as in the range of 8.5 to 10. The pH may be adjusted and buffered by addition of suitable alkaline agents, such as caustic soda and sodium silicate. Soap, such as sodium soap, or other surfactant comprising a hydrophilic and a hydrophobic part, is added to act as a collector. A collector is used for promoting agglomeration of silicone particles and facilitate their charging and flotation. During flotation, a low water hardness in the range of 10-20 dH is preferred, for promoting the agglomeration further. The flotation unit 26 may contain several flotation cells arranged into a series.

A second screening unit 27 is used for fine screening to separate debris from the fibers coming from the flotation, in particular silicone particles originating from the release coating. The fine screening may use slot screens having a slot size equal to or less than 0.25 millimeters, such as in the range of 0.10 to 0.25 millimeters, preferably in the range of 0.10 to 0.20 millimeters. The screening operates under pressure and pulp suspension passing through the slots is accepted.

A washing unit 28, such as a washing unit is a belt filter type machine, is used to separate particles from the pulp suspension by size. Washing is typically performed under wire pressure with a set of two or more rolls, wherein the wire has a mesh size in the range of 36 to 60 micrometers, such that particles with a maximum size less than 30 micrometers are removed. A pulp suspension having a consistency equal to or less than 2 wt. %, such as in the range of 0.5 to 2 wt. % is typically used at the inlet of the washing unit. Clear water F1 is used to wash the filtered fiber mat and to adjust the consistency of the suspension during the washing. Dissolved contaminants are removed with the filtrate. The filtrate may be used as process water F3 upstream in the recycling process.

After washing, a second dewatering unit 29 based on pressing or filtration is used to mechanically remove process water F2 from the washed pulp suspension. Due to the relatively low consistency of the pulp after the washing unit, a twin-wire press is preferred, such that the pulp consistency may be increased efficiently for transport or storage. Advantageously, at the end of the cleaning loop NL1, the pulp suspension is thickened into a consistency equal to or higher than 30 wt. %, preferably equal to or higher than 40 wt. %, such as in the range of 30 to 50 wt. %. The recycled pulp thus obtained from release liner supercalendered Kraft paper REP1 may then be used in a method for manufacturing supercalendered Kraft paper.

As an interim of what was disclosed above, and with reference to FIGS. 8 and 9, the recycling process 16 is arranged to contain operations and conditions, which optimize the separation of fibers from non-fiber components in the pulp suspension. Simultaneously, the caustic loop and the cleaning loop have been configured to adjust the fibrillation of the pulp suspension, such that a pulp drainability is obtained, which is in a range enabling the use of the recycled pulp obtained from the RSCK in a method for manufacturing supercalendered Kraft paper, preferably without further refining.

Hence, the recycling process 16 is arranged to improve the fiber characteristics such that the recycled pulp REP1 may be used without further refining for preparing a stock for supercalendered Kraft paper manufacturing. The operations and conditions homogenize the pulp and develop characteristics such as pulp fibrillation, drainability and pH, which improve the quality of the pulp for a method for manufacturing supercalendered Kraft paper.

A pulp consistency in the range of 30 to 50 wt. % is advantageous in that the pulp fibers are not exposed to a further drying treatment, which may cause further hornification. A pulp consistency in the range of 30 to 50 wt. % is advantageous also when mixing the recycled pulp REP1 together with different pulps, during stock preparation. However, when preparing recycled pulp for storage, the dewatering unit 29 may be supplemented with a drying system, such as a fluffer, to increase the dryness of the pulp, such that a pulp consistency equal to or higher than 80, such as in the range of 80 to 90 wt. % is obtained.

### Properties of Recycled Pulp Obtained from Supercalendered Kraft Paper that has Been Used as a Substrate of a Release Liner

Referring to above, recycled pulp obtained from RSCK has a pH which is typically neutral or alkaline, when determined from aqueous pulp extracts. An alkaline pH during the recycling is preferred, as a higher pH softens the pulp and facilitates the flotation. Alkalinity of the pulp also facilitates the modification of pulp fibrillation and drainability. Recycled pulp obtained from RSCK, when having alkaline pH, needs less energy for refining. The pH, however, may be adjusted, as necessary, prior to using the recycled pulp.

Recycled pulp obtained from RSCK is distinguished from non-recycled BCP due to the extent of hornification of the fibers. This can be measured, for instance, by water retention value, abbreviated as WRV, according to ISO 23714:2014(en). WRV is an empirical measure of the capacity of a pulp sample to hold water. Typically, the WRV of recycled pulp obtained from RSCK is low, such as in the range of 1.3 to 1.6 g/g.

Recycled pulp obtained from RSCK is also distinguished by its water drainage resistance, which is a measure of pulp fibrillation, and which may be determined by the Schopper-Riegler test. The SR number is a measure of the extent of fibrillation in the recycled pulp REP1. The recycled pulp obtained from RSCK may have a SR number equal to or higher than 25, such as in a range from 25 to 65, when determined according to ISO 5267-1. Typically, recycled pulp obtained from RSCK has a SR number equal to or higher than 30, if the aqueous extract, from which the measurement is performed, is process water that contains electrolytes. When measuring the water drainage resistance from dry pulp with standard water in accordance with ISO 5267-1, in conjunction with ISO 14487, the SR number may be higher, such as equal to or higher than 40, since the concentration of electrolytes (salts) in a pulp suspension influences the drainability. Regardless of the initial SR number, upon refining the SR number of the recycled pulp obtained from RSCK develops very quickly. This is a feature of recycled pulp obtained from RSCK, which may be used to distinguish it from other non-recycled pulp components used in a supercalendered Kraft paper. Table 8 (below) demonstrates, by means of an example, the development of SR number (°SR) in recycled pulp obtained from RSCK, as a function of specific energy consumption (SEC) in kWh/t. In the example, a specific edge load (SEL) of 0.3 J/m was applied, using Voith-Sulzer laboratory refiner having 40D hardwood plates. Prior to refining, the recycled pulp obtained from RSCK presented a SR number of 32.

TABLE 8
Development of SR in the recycled pulp obtained
from RSCK, as a function of SEC (kWh/t).

| SEC (kWh/t) | °SR |
|---|---|
| 0 | 32 |
| 10 | 37 |
| 20 | 43 |
| 30 | 48 |
| 40 | 54 |
| 50 | 58 |
| 60 | 63 |
| 70 | 67 |

Advantageously, prior to the mixing in a method for manufacturing supercalendered Kraft paper, the recycled pulp obtained from supercalendered Kraft paper that has been used as a substrate of a release liner has a °SR equal to or higher than 25, such as in a range from 25 to 65, preferably in the range of 30 to 60, most preferably in the range of 40 to 55, when determined according to ISO 5267-1.

Advantageously, when using the recycled pulp obtained from RSCK in a method for manufacturing supercalendered Kraft paper suitable for use as a substrate of a release liner, the recycled pulp obtained from supercalendered Kraft paper that has been used as a substrate of a release liner has a pH which is in the range of 6.0 to 9.1. Preferably the pH is slightly alkaline, such as in the range of 7.0 to 8.5. A recycled pulp obtained from supercalendered Kraft paper that has been used as a substrate of a release liner having an alkaline pH requires less energy for refining of the fibers. A highly alkaline pH may inhibit the functioning of cationic UV curing silicone systems. Most preferably, the pH in the range of 7.5 to 8.2, whereby the drying and the compatibility of the recycled pulp can be optimized for supercalendered Kraft paper production. When determining the pH of dried pulp samples, standard ISO 6588-2 (2020) may be used. When determining the pH of pulp suspension samples from a paper machine, the pH may be measured either directly from the pulp sample (when the consistency is 5 wt. % or less) or from a filtrate (when the consistency is higher than 5 wt. %). A filtrate, as used herein, refers to an aqueous extract. When determining the pH from dry pulp, an amount of 2 grams of dry pulp is cut into pieces, such that each piece has a maximum dimension of 1 centimetre. The cut pieces are mixed with 100 millilitres of deionised water to disperse the pulp with the water such that a suspension having a pulp concentration of 2 wt.-% of water is obtained. The sample thus obtained is heated to a boiling point and boiled for 60 minutes. After boiling, the sample is cooled down, such that the temperature of the sample is in the range of 20 to 25° C., and the sample is filtrated through a filter having a 200 mesh grid, for example by means of a Buchner-funnel, thereby obtaining a filtrate separated from the pulp. The pH is measured from the filtrate thus obtained.

The pulp pH is measured from an aqueous extract having a temperature in the range of 20 to 25° C., by means of a pH meter, using two buffer solutions having pH 4 and pH 7, respectively. Suitable pH meters are, for example, pH-meter CG 840 with electrode N 1042A, Knick pH-meter 766 Calimatic with electrode SE 103 or Mettler-Toledo MP 120, used according to the manufacturer's instructions.

When manufacturing recycled pulp from a release liner supercalendered Kraft paper as disclosed above, the removal of silicone-based particles is not complete. The recycled pulp obtained from RSCK still contains traces of the cured release coating, in very small size particles, which are chemically rather inert. The maximum particle size of the silicone-based particles is typically in the range of 100 to 150 micrometers and limited by the slot size used in the fine screening in the cleaning loop NL1. While detectable, the amount of silicone-based particles in the recycled pulp obtained from RSCK has not been observed to cause difficulties, upon manufacturing supercalendered Kraft paper on a paper machine. The amount of silicone-based particles may be measured with an Energy Dispersive X-ray Spectroscopy from a test specimen which is combusted at 900° C., in accordance with Tappi standard T 413, which detects the oxides of silicon. Typically, a supercalendered Kraft paper comprising recycled pulp from RSCK contains silicon in an amount of equal to or less than 0.3 wt. %, preferably equal to or less than 0.28 wt. %, most preferably equal to or higher than 0.25 wt. %, such as in the range of 0.01 to 0.3 wt. %, determinable as dry matter content from a paper specimen which is combusted at 900° C. with an Energy Dispersive X-ray Spectroscopy, in accordance with Tappi standard T 413.

### Experimental Studies

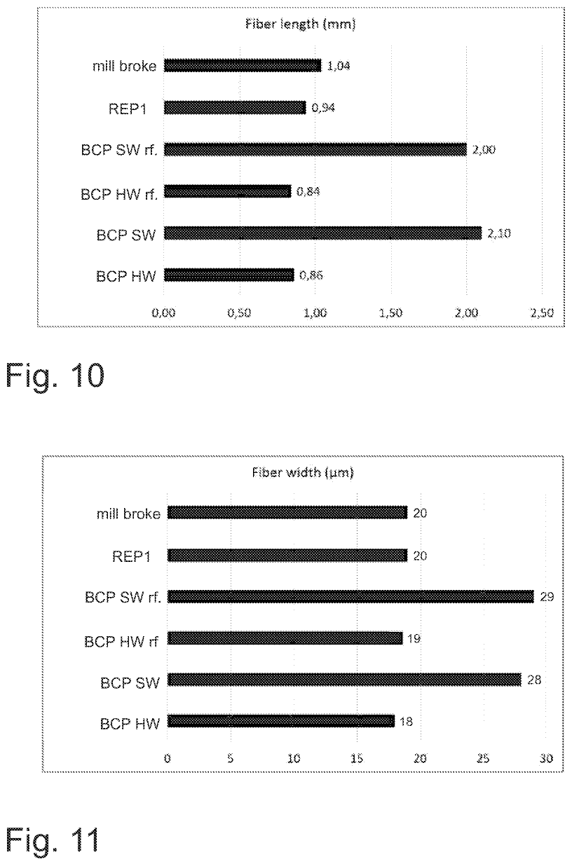

Reference is made to FIGS. 10-17. Experimental studies were prepared to assess the characteristics of the recycled pulp obtained from RSCK and to determine its effects in a method for manufacturing supercalendered Kraft paper.

### Experimental Study B1—Pulp Properties of Recycled Pulp Obtained from RSCK

In an experimental study, pulp properties of recycled pulp obtained from RSCK were measured and compared to properties of non-recycled bleached chemical pulps and mill broke used at a paper mill for supercalendered Kraft paper production. Below are listed the pulp types and their abbreviation in the experimental study:
BCP SW northern bleached softwood kraft pulp (coniferous trees)
BCP HW bleached hardwood kraft pulp (eucalyptus)
BCP SW rf. mill refined BCP SW (SEC 240 kWh/t)
BCP HW rf. mill refined BCP HW (SEC 135 kWh/t)
mill broke mill broke obtained from supercalendered Kraft paper production REP1 recycled pulp obtained from RSCK

The consistency of the pulps in the study was 4 wt. %. The properties of the non-recycled bleached chemical pulps were measured before and after refining, to compare the properties of the recycled RSCK and the non-recycled bleached chemical pulps.

### Pulp Analyses

The pH of the pulps disclosed above were measured from aqueous pulp extracts according to ISO 6588-2 (2020). The results are shown in Table 9 (below).

TABLE 9
Measured pH of pulp samples.

| Sample | pH |
|---|---|
| BCP SW | 5.3 |
| BCP HW | 5.1 |
| REP1 | 6.8 |
| mill broke | 5.3 |

The results represent an average of measurements, during which the recycled pulp obtained from RSCK varied in the range of 6.8 to 7.3. The measured pH in the recycled pulp obtained from RSCK was clearly higher than in the non-recycled chemical pulps made of softwood or hardwood. The measured pH in the recycled pulp obtained from RSCK was clearly higher than in the mill broke, as well.

Pulps as disclosed above were further analysed by means of a fiber furnish analysis according to ISO standards ISO 9184-1 and 9184-4:1990. A fiber furnish analysis is capable to identify papermaking fibers from a sample. The analysis may further be used to quantify average dimensions of the different fiber types detected in a sample. The wood species used in a pulp may be distinguished by comparison method, wherein a sample fiber is compared against a known reference fiber. Valmet Fiber Image Analyzer (Valmet FS5) is an example of a device, which can be used according to the manufacturer's instructions to perform the fiber furnish analysis. For example, automated optical analysis, such as an ultra high resolution (UHD) camera system equipped with image analysis software, may be used to acquire a greyscale image of a sample, of which image the properties of the fibers in the sample may be determined. The greyscale image may be acquired from a sample placed in a transparent sample holder, such as a cuvette, using a 0.5 millimetre depth of focus according to ISO 16505-2 standard. Valmet Fiber Image Analyzer (Valmet FS5) may further be used to determine fiber dimensions, such as fiber length and fiber width, as well as length weighted distribution of the pulp fibers, by means of automated optical analysis using unpolarized light, according to ISO 16065-2:2014.

Reference is made to FIG. 10, which shows the average length in millimeters of fibers in recycled pulp obtained from RSCK and other pulp types, measured as length weighted average fiber length, using a Valmet Fiber Image Analyzer (Valmet FS5). The recycled pulp obtained from RSCK comprises an average fiber length of 0.94 millimeters. The non-recycled BCP made of hardwood comprises an average fiber length of 0.86 millimeters, which upon refining was reduced to 0.84 millimeters. Hence, the average fiber length of recycled pulp obtained from RSCK is higher than the average fiber length of non-recycled BCP made of hardwood. The non-recycled BCP made of softwood comprises an average fiber length of 2.10 millimeters, which upon refining was reduced to 2.00 millimeters. Hence, the average fiber length of recycled pulp obtained from RSCK is significantly less than the average fiber length of non-recycled BCP made of softwood. Mill broke had an average fiber length of 1.04 millimeters.

Reference is further made to FIG. 11, which shows comparative data of average fiber width in micrometers of fibers in recycled pulp obtained from RSCK and other pulp types, measured, using the Valmet Fiber Image Analyzer (Valmet FS5). The recycled pulp obtained from RSCK comprises an average fiber width of 20 micrometers. The non-recycled BCP made of hardwood comprises an average fiber width of 18 micrometers, which upon refining was increased to 19 micrometers. Hence, the average fiber width of recycled pulp obtained from RSCK is larger than the average fiber width of non-recycled BCP made of hardwood. The non-recycled BCP made of softwood comprises an average fiber width of 28 micrometers, which upon refining was increased to 29 micrometers. Hence, the average fiber width of recycled pulp obtained from RSCK is significantly less than the average fiber width of non-recycled BCP made of softwood. Mill broke had an average fiber width of 20 micrometers.

Hence, the average fiber length and width of recycled pulp obtained from RSCK is closer to the average fiber length of non-recycled BCP made of hardwood or broke, but clearly distinguished from the average fiber length of non-recycled BCP made of softwood.

The length weighted distribution of the pulp fibers was further analysed using Valmet Fiber Image Analyzer (Valmet FS5), according to the manufacturer's instructions. In the analysis, fibers were defined to be the fraction of the pulp that included particles having a width in the range of 10 to 75 micrometers and a length in the range of 0.2 to 7.0 millimeters. Fines were defined to be the fraction of the pulp that included particles having a width in the range of 10 to 75 micrometers and a length less than 0.2 millimeters. Fibrils were defined to be the fraction of the pulp that included particles having a width less than 10 micrometers and a length longer than 0.2 millimeters. Flakes were defined to be the fraction of the pulp that included particles having a width less than 200 micrometers and a length less than 0.2 millimeters. Fibrils are typically particles generated from the secondary wall of the wood cell layer structure, which due to their elongated shape may improve bonding properties of the pulp. Flakes are typically particles generated from the middle lamella and primary wall of the wood cell layer structure, which tend to decrease the bonding properties of the pulp. The flakes scatter light and may hence affect the optical properties of the pulp by increasing opacity and decreasing transparency.

The content of fines in a bleached chemical pulp, such as bleached kraft pulp, varies naturally depending on the used wood species. The content of the fines in a pulp varies also due to pulp treatments, such as refining and recycling, as disclosed above. The length weighted distribution of fines is a fundamental property of pulp, which affects inter alia the formation of paper web during manufacturing. The pulp characteristics also have an effect on the tensile strength, the burst strength, the fold endurance and the tear resistance of a paper.

The results of the analysis was, that the amount of fines in the recycled pulp obtained from RSCK was 16.3% of the total amount of fibers in the recycled pulp, when determined as length weighted average fiber length, by means of an automated optical analysis using unpolarized light according to ISO 16065-2:2014. The amount of fines in the recycled pulp obtained from RSCK was in the same level as in the mill refined non-recycled bleached chemical pulp made of hardwood. The amount of fibrils in the recycled pulp obtained from RSCK, unexpectedly, was much higher than in the mill refined non-recycled bleached chemical pulp made of hardwood, but lower than in the mill refined non-recycled bleached chemical pulp made of softwood. The results demonstrate that the recycled pulp obtained from supercalendered Kraft paper that has been used as a substrate of a release liner contains particles derived from the recycled pulp having a length less than 200 micrometers in an amount equal to or higher than 10%, such as in a range from 10 to 30%, preferably in the range of 12 to 20%, most preferably in the range of 15 to 17%.

The Valmet Fiber Image Analyzer also provided results of the amount fiber deformations, such as fiber kinks and fiber curl, in the pulps. Fiber kinks and curls tend to decrease the tensile strength of the formed paper, due to reduced bonding ability of the fibers in a fiber network. Of notice, the number of kinks in the recycled pulp obtained from RSCK was 3250 1/m, which was considerably higher than in the non-recycled bleached chemical pulps after refining or in the mill broke. The number of kinks in the non-recycled bleached chemical pulp made of hardwood was 2880 1/m before refining and 2310 1/m after refining. The number of kinks in the non-recycled bleached chemical pulp made of softwood was 3410 1/m before refining and 2730 1/m after refining.

Measured fiber analysis results of recycled pulp obtained from RSCK, non-recycled bleached chemical pulps (before and after mill refining) and mill broke used at a paper mill for supercalendered Kraft paper production in the experimental study are presented in Table 10 (below). Comparison of the samples demonstrates that the fiber characteristics and the relative amount of fiber fractions is different in the recycled pulp obtained from RSCK.

TABLE 10
Fiber analysis results and properties of recycled pulp obtained from
RSCK (REP1), non-recycled bleached chemical pulps (before and
after mill refining) and mill broke used at a paper mill for
supercalendered Kraft paper production.

| | Fiber | Fiber | | | | | | | |
|---|---|---|---|---|---|---|---|---|---|
| | length | width | Fines | Flakes | Fibrils | Kinks | Curl | | WRV |
| Sample | (mm) | (um) | (%) | (%) | (%) | (1/m) | (%) | °SR | (g/g) |
| BCP SW | 2.10 | 28 | 15.0 | 12 | 1.9 | 3410 | 16 | 13 | 1.1 |
| BCP HW | 0.86 | 18 | 14.0 | 15 | 0.3 | 2880 | 10 | 18 | 1.2 |
| BCP SW rf. | 2.00 | 29 | 20.5 | 20 | 7.5 | 2730 | 15 | 32 | 1.9 |
| BCP HW rf. | 0.84 | 19 | 16.3 | 18 | 0.6 | 2310 | 8 | 52 | 1.9 |
| REP1 | 0.94 | 20 | 16.3 | 19 | 3.9 | 3250 | 10 | 43 | 1.5 |
| mill broke | 1.04 | 20 | 20.5 | 24 | 2.8 | 2650 | 10 | 53 | 1.6 |

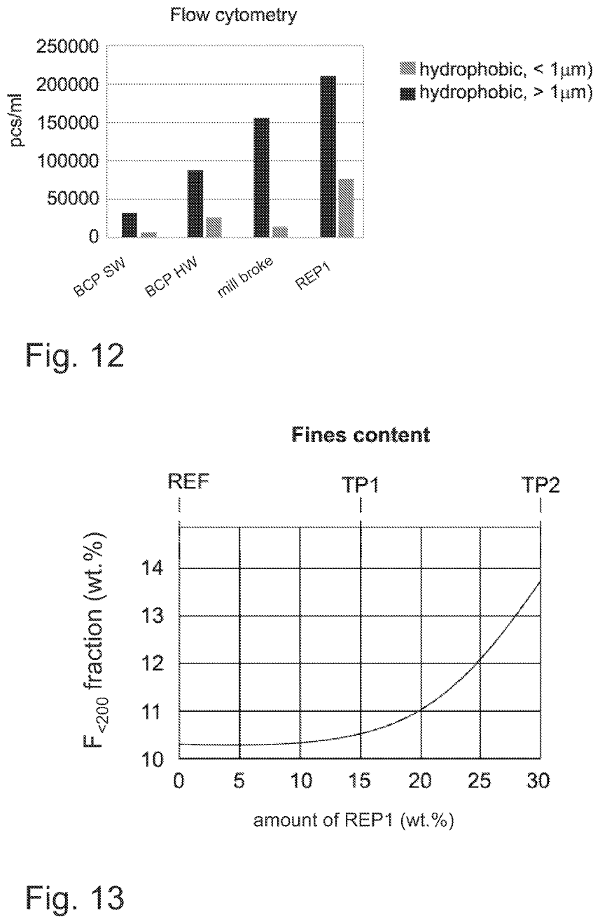

Reference is made to FIG. 12. The pulps as disclosed above were further analysed on the basis of the hydrophobic nature of the pulp. The hydrophobicity of the particles in the pulp was measured by means of flow cytometry, which is a well-known analytical method for counting, identifying and sorting particles based on selected characteristics. A S_{y} smex CyFlow Cube 6 (V2m) bench-top flow cytometer was used for the analysis. Representative samples of 20 ml were collected from the paper machine and diluted with ultrapure water 5-fold and the diluted and well mixed sample was then filtered through a 200 mesh screen. A 50 ml aliquot of the filtrate was collected for further dilution. A series of dilutions (in the range of 10-1000 fold) was prepared with ultrapure water such that a suitable dilution was obtained, which contained particles in an amount that resulted into 700-1000 events per second, when analysed with the flow cytometer. A volume on 20 ml of the dilution to be analysed was mixed with 1 ml of Nile red stain, which was used as a fluorescent marker to selectively stain hydrophobic moieties in the samples. Prior to analyzing the samples, the flow cytometry was calibrated to size standards with 3 μm commercial polystyrene beads. Relative hydrophobicity (>10) was used for gating the particles. The particles in each sample were further sorted based on their size, such that hydrophobic particles with a diameter of 1 micrometer or less was denoted as small, whereas hydrophobic particles with a diameter over 1 micrometer were denoted as large. The results indicate that the recycled pulp obtained from RSCK contains in the range of 2-3 times higher amount of large and small hydrophobic particles than non-recycled BCP made of hardwood. The recycled pulp obtained from RSCK contains close to 10 times higher amount of large and small hydrophobic particles than non-recycled BCP made of softwood. The difference to mill broke was also clear. While most of the hydrophobic particles in all of the analysed samples belonged to the group of large particles, that is, over 1 micrometer in diameter, the highest relative difference between the recycled pulp obtained from RSCK and other pulp types was measured in the group of small particles. The amount of hydrophobic particles in a sample, in units of pieces per millilitre (pcs/ml) and the total measured particle amount in the samples (pcs) is shown in Table 11 (below).

TABLE 11
Amount of hydrophobic particles and total particle amount in
samples measured by flow cytometry.

| | Hydrophobic | |
|---|---|---|
| | particles | Total particle |
| Sample | (pcs/ml) | amount (pcs) |
| BCP SW | 39000 | 2400000 |
| BCP HW | 110000 | 6000000 |
| REP1 | 310000 | 8400000 |
| mill broke | 170000 | 14000000 |

It was contemplated that the observed increase of hydrophobic particles, particularly small hydrophobic particles, in the recycled pulp obtained from RSCK, would be due to silicone polymer residues form the release coating. However, despite the amount of hydrophobic particles in the recycled pulp obtained from RSCK, no detectable problems were observed upon supercalendered Kraft paper production in the experiments, with respect to runnability or paper quality.

### Experimental Study B2—SCK Paper Comprising Recycled Pulp Obtained from RSCK

In a second experimental study, supercalendered Kraft paper having grammage of 53 g/m2 and a thickness of 48 um was produced, such that the amount of recycled pulp obtained from RSCK in the stock was varied. The amount of recycled pulp obtained from RSCK was varied from 0 to 30 wt. %, referring to the dry matter content of the produced supercalendered Kraft paper, according to SCAN-P 39:80. The ratio of non-recycled bleached chemical pulp produced from hardwood to the non-recycled bleached chemical pulp produced from softwood was maintained constant. Hence, the non-recycled BCP contained 35 wt. % of non-recycled BCP produced from softwood and 65 wt. % of non-recycled BCP produced from hardwood. Thus, upon increasing the amount of recycled pulp obtained from RSCK in the stock, the amount of BCP was decreased such that the share of non-recycled BCP produced from hardwood to softwood was maintained. The amount of broke was maintained the same, 12 wt. %, in all experiments.

Samples were measured at various trial points. A composition, which contained only non-recycled bleached chemical pulps and broke, but did not contain recycled pulp obtained from RSCK, is marked in the FIGS. 13-17 as a reference point, and abbreviated as REF. A composition, which contained 15 wt. % of recycled pulp obtained from RSCK, is marked in the FIGS. 13-17 as a trial point 1, and abbreviated as TP1. A composition, which contained 30 wt. % of recycled pulp obtained from RSCK, is marked in the FIGS. 13-17 as a trial point 2, and abbreviated as TP2. The stock composition of the reference point and trial points 1 and 2, is described in Table 12 (below).

TABLE 12
Composition of stock at reference and trial points 1 and 2 in
experimental studies. The abbreviation ‘BCP tot.’ refers to the total amount of
non-recycled bleached chemical pulp in the stock, in wt. %. Broke refers to the
amount of mill broke wt. % in the stock, in wt. %. REP1 refers to the amount of
recycled pulp obtained from RSCK in the stock, in wt. %. The last column on
the right refers to the share of each component (BCP SW, BCP HW, broke,
REP1) in the stock, which sums up to 100 wt. %.

| | BCP tot. | broke | REP1 | BCP SW/BCP HW/broke/REP1 |
|---|---|---|---|---|
| Sample | (wt. %) | (wt. %) | (wt. %) | (wt. %) |
| REF | 88% | 12% | 0% | 31/57/12/0 |
| TP1 | 73% | 12% | 15% | 26/47/12/15 |
| TP2 | 58% | 12% | 30% | 20/38/12/30 |

### Fines Content at The Machine Chest (BMN Method)

Reference is made to FIG. 13. The effect of the recycled pulp obtained from RSCK on supercalendered Kraft paper production was assessed by measuring the development of fines content at the machine chest of a paper machine as a function of the amount of recycled pulp obtained from RSCK in the stock. The fines content, in this context, refers to fibrous material in the pulp that was determined as the F_{<200} fraction with McNett classifier according to SCAN-CM 6:05, using a 20 minutes fractionation time, a set of 16, 28, 48 and 200 mesh wires, and weighed filter papers (Macherey-Nagel MN616, 125 mm diameter) for collecting the fibre fractions. The method describes a fibre-fractionation procedure, wherein the fibres in a pulp suspension are grouped into fractions of different average fibre size. The mass of the fibres retained in a fraction is expressed as a percentage of the dry mass of the original sample. The retained F<200 fraction serves as an indication of how much the fines content changes in supercalendered Kraft paper production due to an increase in the amount of pulp obtained from RSCK, when the relative ratio of the BCP SW and BCP SW is maintained, the amount of broke mill staying the same. The results evidence that when the amount of recycled pulp obtained from RSCK in the supercalendered Kraft paper is in the range of 0 to 10 wt. %, the fines content remains relatively stable, in the range of 10.2 wt. % to 10.5 wt. %.

However, unexpectedly, when the amount of recycled pulp obtained from RSCK in the supercalendered Kraft paper is equal to or higher than 10 wt. %, the fines content begins to increase more rapidly. In particular, when the amount of recycled pulp obtained from RSCK in the supercalendered Kraft paper is equal to or higher than 15 wt. %, such as in the range of 15 to 30 wt. %, the fines content in the fiber furnish of the supercalendered Kraft paper increases very rapidly. During the experiment, when the amount of recycled pulp obtained from RSCK in the supercalendered Kraft paper was in the range of 0 to 30 wt. %, the fines content increased from 10.2 wt. % to 13.8 wt. %. The fines content had an effect to the characteristics of the paper. The effect was detectable already upon forming the paper web. The results indicate that the amount of recycled pulp obtained from RSCK in the stock may be used for adjusting the retention level, which describes the ability of the formed paper web to retain fine particles on the web, and therefore the balance between drainage and formation of the paper web.

### Water Retention Value at the Machine Chest

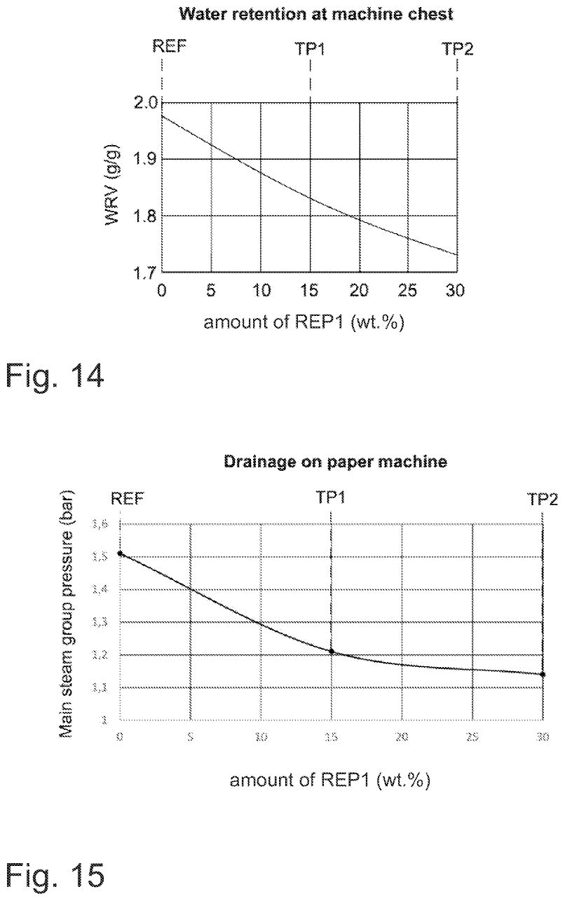

Reference is made to FIG. 14. The effect of the recycled pulp obtained from RSCK on supercalendered Kraft paper production was further assessed by measuring the water retention value, abbreviated as WRV, at the machine chest according to ISO 23714: 014(en). The WRV was determined as an average of two parallel samples, each sample amount consisting of 1 g of dry pulp diluted into 500 ml of water and having a temperature of 23±3° C. Materials and methods as listed below were used:
Beckman Coulter Avanti J-301 laboratory centrifuge
Centrifugal force of 3000 g±50 g, 30 minutes
JS 7,5 rotor (speed 5350; RPM 5289)

The sample was weighed first time after the centrifugation. The sample was then dried overnight (12h) at 105±2° C. and cooled down to a room temperature of 23±3° C. in an excicator. The sample was then weighed a second time. A laboratory scale (0,0001 g precision) was used for the weighing.

The water retention value was calculated according to equation 1 below:

$$W R V = \frac{m 1}{m 2} - 1 , \qquad Equation 1$$

wherein
m1=mass of sample after centrifugation, in grams
m2=mass of sample after drying, in grams.

The results evidence that a replacement of non-recycled BCP with recycled pulp obtained from RSCK leads to a steady decrease in the water retention value, which is inversely proportional to the amount of the recycled pulp obtained from RSCK in the supercalendered Kraft paper. Each replacement of 10 wt. % of non-recycled BCP by recycled pulp obtained from RSCK results into a WRV decrease in the range of 0.1 g/g in the supercalendered Kraft paper. The decrease in the WRV was evidenced over the whole range. At the reference point, the WRV was 1.98 g/g. At the trial point 1, the WRV was 1.83 g/g. At the trial point 2, the WRV was 1.72 g/g. The water retention level analysis results support and validate the observations of the fines content analysis disclosed above. The correlation of WRV as a function of the amount of recycled pulp obtained from RSCK in the stock demonstrates that recycled pulp obtained from RSCK in the stock may be used for adjusting the water retention level. The lower WRV of the fibers in the recycled pulp obtained from RSCK, compared to the fibers in the non-recycled BCP, is advantageous upon drying. A reduced amount of water absorbed into the fiber network at the machine chest indicates a better dimensional stability of the paper upon drying. Thus, considering the trend of development of the fines content and the drainage discussed hereafter, the supercalendered Kraft paper advantageously contains recycled pulp obtained from supercalendered Kraft paper that has been used as a substrate of a release liner equal to or less than 50 wt. %, such as in the range of 5 to 50 wt. %, preferably in the range of 10 to 45 wt. %, most preferably in the range of 15 to 40 wt. % of the paper, when determined as dry matter content according to SCAN-P 39:80. Further, the stock at a machine chest of a paper machine has a water retention value which is in the range of 1.5 to 1.9 g/g, preferably in the range of 1.55 to 1.85, most preferably in the range of 1.6 to 1.8, determinable according to ISO 23714:2014 from a sample having a dry matter content of 1 gram.

### Paper Drainage—Main Steam Group Pressure at the Drying Section

Reference is made to FIG. 15. The effect of the recycled pulp obtained from RSCK on supercalendered Kraft paper production was next assessed by measuring the main steam group pressure at a paper machine during supercalendered Kraft paper production. The main steam group pressure is an indication of the drainage and direct evidence of the amount of energy consumed, when drying the paper. The results evidence that the drainage improves, when the amount of recycled pulp obtained from RSCK in the supercalendered Kraft paper increases. The formed supercalendered Kraft paper had a higher dry matter content. Further, a supercalendered Kraft paper comprising a higher amount of recycled pulp obtained from RSCK needed less steam pressure for drying. Unexpectedly, the drainage, when measured by means of the main steam group pressure, seemed to be most effective, when the amount of recycled pulp obtained from RSCK in the supercalendered Kraft paper was equal to or less than 15 wt. %, such as in the range of 5 to 15 wt. %. Already an amount of 5 wt. % of recycled pulp obtained from RSCK in the composition required 0.1 bar less of steam pressure for drying the supercalendered Kraft paper, as evidenced by FIG. 9. An amount of 15 wt. % of recycled pulp obtained from RSCK in the composition required 0.3 bar less of steam pressure for drying the supercalendered Kraft paper.

### Paper Cross-Directional Profiling at the Reeler

The effect of the recycled pulp obtained from RSCK on supercalendered Kraft paper production was further evaluated at the drying section. The supercalendered Kraft paper samples demonstrated a density in the range of 1100±11 g/m³ and a transparency in the range of 50±1%. The characteristics of samples produced according to the reference and trial points compositions are presented in Table 13 (below). The trial points were run with the same speed and settings for all the compositions (REF, TP1, TP2), such that the effect of recycled pulp obtained from RSCK to the supercalendered Kraft paper could be evaluated.

TABLE 13
Characteristics of supercalendered Kraft paper samples.

| | Grammage | Thickness | Density | Transparency |
|---|---|---|---|---|
| Sample | (g/m²) | (μm) | (g/m³) | (%) |
| REF | 53.01 | 48.431 | 1098.0 | 50.27 |
| TP1 | 52.85 | 48.227 | 1110.2 | 49.86 |
| TP2 | 53.32 | 48.262 | 1099.8 | 49.25 |

The results indicate that recycled pulp obtained from RSCK enables to maintain quality characteristics of supercalendered Kraft paper, such as density and transparency, at a sufficient level. The combination of preserved density and transparency serves as an indirect indicator of this.

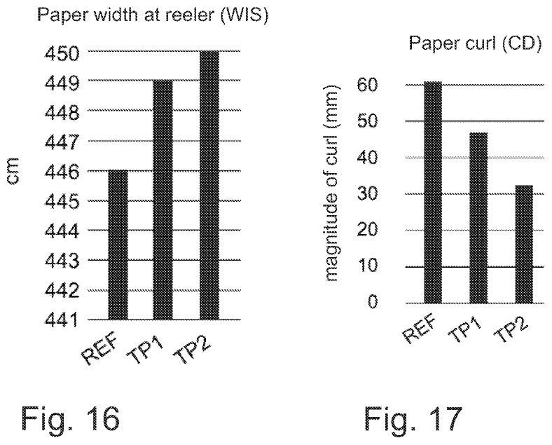

Reference is made to FIG. 16. The paper width was measured from supercalendered Kraft paper samples at the reference point, trial point 1 and trial point 2. The paper width was measured at the reeler, in centimeters, by means of Web Imaging System, abbreviated as WIS, which is an automated image analysis system provided by ABB. The system was used according to manufacturer's instructions. The width of the paper indicated in FIG. 16 is an average value of 8 measurements along the surface of the paper in the cross-direction S_{y}, which is perpendicular to the machine direction Sₓ. The results evidence that a replacement of non-recycled BCP with recycled pulp obtained from RSCK leads to reduced shrinkage of the supercalendered Kraft paper, which is directly proportional to the amount of the recycled pulp obtained from RSCK in the supercalendered Kraft paper. A replacement of 15 wt. % of non-recycled BCP by recycled pulp obtained from RSCK resulted into a supercalendered Kraft paper, which demonstrated 3 cm less shrinkage than the reference. A replacement of 30 wt. % of non-recycled BCP by recycled pulp obtained from RSCK resulted into a supercalendered Kraft paper, which demonstrated 4 cm less shrinkage than the reference. The WIS results were validated in an independent trial run, wherein the paper was profiled off-line from 30 calendered and uncalendered paper samples at the reeler, by means of a Tapio PMA, which is an automated paper quality control system provided by Tapio technologies. The system was used according to manufacturer's instructions. The results of the latter independent trial run with Tapio PMA validated the paper width results of the first trial run. In samples without recycled pulp obtained from RSCK (REF), the measured shrinkage along the surface of the paper in the cross-direction S_{y} was 3.6%. In samples containing 15 wt. % of recycled pulp obtained from RSCK (TP1), the measured shrinkage along the surface of the paper in the cross-direction S_{y} was 3.0%. In samples containing 30 wt. % of recycled pulp obtained from RSCK (TP2), the measured shrinkage along the surface of the paper in the cross-direction S_{y} was 2.9%. During the latter trial run, also the grammage and thickness variability of the uncalendered paper along the surface of the paper in the cross-direction S_{y} was simultaneously determined from the 30 paper samples by means of the

Tapio PMA, according to the manufacturer's instructions. The grammage variability analysis indicated, that the standard deviation of samples at the trial points 1 and 2, containing recycled pulp obtained from RSCK, was 0.5 g/m². This was on the same level as the standard deviation of samples at the reference point, which did not contain recycled pulp obtained from RSCK (REF). The grammage variability (max-min) was in the range of 3.1 to 3.6 g/m², in all the measured sample compositions (REF, TP1, TP2). The thickness variability analysis indicated that the standard deviation of samples at the trial points 1 and 2, containing recycled pulp obtained from RSCK (TP1, TP2) was 0.4 μm, which was on the same level as the standard deviation of samples at the reference point, which did not contain recycled pulp obtained from RSCK (REF). The thickness variability (max-min), however, demonstrated a decrease in variability when the amount of recycled pulp obtained from RSCK was larger. In the reference sample (REF), the thickness variability (max-min) was 2.4 μm, whereas the thickness variability (max-min) of the trial points 1 and 2 (TP1, TP2) was 1.9 μm and 2.1 μm, respectively. In addition to reduced shrinkage, the replacement of non-recycled BCP with recycled pulp obtained from RSCK lead into a decrease in the thickness variability, which correlated with the shrinkage results, while maintaining the grammage variability. Thus, both the shrinkage and thickness variability at a paper machine correlated with the amount of the recycled pulp obtained from RSCK. Reduced shrinkage and stable grammage variability are indicators of improved dimensional stability.

### Induced Curl Test on Supercalendered Kraft Paper

Reference is made to FIG. 17. The supercalendered Kraft paper samples produced in the industrial scale trial run were further evaluated for induced curl into the cross-direction S_{y}, denoted as paper curl (CD). A curl was induced in conditions of 1 minute at a temperature of 150° C. (laboratory oven) and measured immediately afterwards. The induced curl method was selected, since it is indicative of the processability of a supercalendered Kraft paper when used as a substrate for a release coating. A release coating is typically cured in conditions resembling the selected situation.

A modified version of a test method ISO 11556:2005(en) was used for measuring the induced curl. A rectangular test piece from the middle of a paper sheet that had been allowed to stabilize in NTP conditions (25° C., 1 bar) 24 hours after production was cut, having a shape with a length of 10 cm (in the cross-direction S_{y} of the paper) and a width of 5 cm (in the machine direction Sₓ of the paper). The test piece was set on a cylindrical holder having a diameter of 10 mm and a slot extending over 5 cm along the length of the holder, such that the test piece, when set into the slot, was suspended by the slot from its whole width from the middle, each half of the test piece length thus able to extend freely for a distance of 4.5 cm in opposite directions. The cylindrical holder was attached on a curl template for measuring the magnitude of the induced curl. Prior to inducing curl, the test specimen was aligned parallel with a reference place. The reference plane was given a value of zero. Since the induced curl on the suspended test piece approximates the arc of a circle, markings were imprinted on the template which indicated an angle of curvature deviating from the reference plane. The magnitude of curl was thus imprinted into the template as the angle of curvature of the curled test piece from a reference plane, in units of degree of angle. The curl of the test piece was compared to the angle of curvature imprinted on the curl template; the curvature on both sides was recorded. Two test pieces were measured and the four recorded values were averaged. The result of the curl test was thus an70imulate value of the recorded four values. If the recorded curl was towards wire-side, the curl was positive. If the recorded curl was towards top-side, the curl was negative. The wire-side, in this context, refers to the side of the paper that upon forming the paper web has been in contact with the papermaking machine's forming wire. The top-side, in this context, refers to the opposite side of the paper.

The results evidence that a replacement of non-recycled BCP with recycled pulp obtained from RSCK leads to a steady decrease in the curl value, which is proportional to the amount of the recycled pulp obtained from RSCK in the supercalendered Kraft paper. In samples without recycled pulp obtained from RSCK (REF), the measured curl was 61 mm. In samples containing 15 wt. % of recycled pulp obtained from RSCK (TP1), the measured curl was 47 mm. In samples containing 30 wt. % of recycled pulp obtained from RSCK (TP2), the measured curl was 32 mm. Therefore, a replacement of 15 wt. % of non-recycled BCP by recycled pulp obtained from RSCK resulted into a curl decrease of 23% in the supercalendered Kraft paper. Moreover, a replacement of 30 wt. % of non-recycled BCP by recycled pulp obtained from RSCK resulted into a curl decrease of 48% in the supercalendered Kraft paper. The decrease in the curl was evidenced in all measured samples. The induced curl results support and validate the observations disclosed above. Thus, when considering in light of the improved dimensional stability and the drainage discussed above, the supercalendered Kraft paper advantageously contains recycled pulp obtained from supercalendered Kraft paper that has been used as a substrate of a release liner equal to or less than 50 wt. %, such as in the range of 5 to 50 wt. %, preferably in the range of 10 to 45 wt. %, most preferably in the range of 15 to 30 wt. % of the paper, when determined as dry matter content according to SCAN-P 39:80.

### Paper Strength Properties

The supercalendered Kraft paper samples produced in the industrial scale trial run were further evaluated for strength properties. The tensile strength in the machine direction (MD) Sₓ and in the cross-direction (CD) S_{y}, the strain at break in the MD, and the tensile energy absorption in the MD were measured in accordance with ISO 1924-3.

Tensile strength can be used as an indication of the potential resistance of the supercalendered Kraft paper to a web break, when the supercalendered Kraft paper is used as a substrate of a release liner in a labelling operation. The strain at break can be used as an indication of how well the paper will conform to irregular shapes and, along with tensile energy absorption, as an indication of the paper's performance under dynamic straining and stressing. Tensile energy absorption is a measure of the ability of a paper to absorb energy. Tensile energy absorption thus expresses the toughness of the sheet. The parameters thus predict the performance of paper, especially when that paper is subjected to an uneven stress or a dynamic stress. Table 14 (below) indicates the results measured from supercalendered Kraft paper samples that did not contain recycled pulp obtained from RSCK (REF), from supercalendered Kraft paper samples that contained 15 wt. % of the recycled pulp obtained from RSCK (TP1) and from supercalendered Kraft paper samples that contained 30 wt. % of the recycled pulp obtained from RSCK (TP2).

TABLE 14
Comparative results (MD and CD) from supercalendered Kraft paper
samples.

| | MD tensile | CD tensile | MD strain | MD tensile energy |
|---|---|---|---|---|
| | strength | strength | at break | absorption |
| Sample | (kN/m) | (kN/m) | (%) | (J/m²) |
| REF | 5.15 | 2.78 | 1.89 | 66.0 |
| TP1 | 5.38 | 2.76 | 1.90 | 67.5 |
| TP2 | 5.29 | 2.83 | 1.81 | 65.3 |

The results indicate that the paper strength, when determined as tensile strength, strain at break and tensile energy absorption, remained at sufficiently high level in the samples, despite the replacement of non-recycled BCP with recycled pulp obtained from RSCK. No significant changes were observed in the paper strength or orientation properties during the trial.

As a summary of the results, the compatibility of recycled pulp produced from release liner supercalendered Kraft paper is excellent for supercalendered Kraft paper production. Positive effects in supercalendered Kraft paper manufacturing process, such as improved dewatering both when forming the paper web and at the press section, improved drainage at the drying section, better were measured with several different methods, while maintaining the properties of the supercalendered Kraft paper at sufficient level for use as a substrate for a release liner. The improved manufacturing process was perceivable also in the produced supercalendered Kraft paper, which demonstrated reduced shrinkage, better dimensional stability and reduced curl.

### A SCK Paper Comprising Non-Recycled BCP, BCTMP and Recycled Pulp Obtained from RSCK

### Experimental Study C1—Comparison of SCK Paper Fiber Furnishes Comprising BCP, BCTMP and Recycled Pulp Obtained from RSCK by Means of Computational Modelling

In a further experimental study, effects due to changes in a fiber furnish was studied by means of computational modelling.

The computational modelling was performed with SoftaCell, which is a mathematical modelling software developed by a commercial vendor (GloCell Oy) for multivariable optimization and simulation. The software is designed for simulating a change which would occur upon varying a pulp or a paper quality parameter, such as fiber furnish mixture and degree of refining, a certain amount from a given reference situation. Historical data of the principal factors contributing to paper quality, that is, previously measured quality characteristics of specific pulp samples and fiber furnish mixtures from a paper machine and/or laboratory experiments, was used to create a comprehensive database model for the software, which then used the existing data to simulate the effect of the varied parameter to the process and/or product.

SCK paper production was modelled by first forming a reference SCK paper trial point REF_0 with known fiber furnish composition, comprising non-recycled BCP from hardwood and softwood and BCTMP. This reference point was thereafter compared to simulated trial points, wherein the content of the fiber furnish was changed in respect of the amount of non-recycled BCP from hardwood, non-recycled BCP from softwood, BCTMP, and/or recycled pulp obtained from RSCK.

The modelling was performed using the following parameters for the pulps in the fiber furnish recipes:
BCP SW, denoting bleached chemical pulp from softwood (pine)
   °SR=52
   SEC=162 kWh/t
BCP HW, denoting bleached chemical pulp from hardwood (birch)
   °SR=35
   SEC=124 kWh/t
BCTMP, denoting bleached chemithermomechanical pulp obtained from hardwood (aspen) and softwood (spruce)
   20 SR=43
   SEC=120 kWh/t
REP1, denoting recycled pulp obtained from RSCK
   °SR=51
   not refined

Simulations were performed on supercalendered Kraft paper having grammage of 65 g/m².

In the simulations, five trial series were performed. In all trial series, the reference situation was the same sample REF_0, wherein the fiber furnish contained
bleached chemical pulp from softwood (pine) in an amount of 25 wt. %,
bleached chemical pulp from hardwood (birch) in an amount of 50 wt. %, and
bleached chemithermomechanical pulp obtained from hardwood (aspen) and softwood (spruce) in an amount of 25 wt. %,
the pulps forming the fiber furnish up to 100 wt. %.

The quality characteristics of the reference situation were known from prior measurements performed on supercalendered Kraft paper samples derived from a paper machine.

The performed simulations tested a hypothesis that BCTMP together with RSCK could replace exceptionally high amounts of bleached chemical pulp in the fiber furnish, while maintaining a sufficient formation and enabling to produce SCK paper having incompressibility, smoothness and density in a level suitable for use as a substrate of a release liner.

Simulation 1—SCK wherein the BCP HW and BCP SW Amounts are Fixed

A first series aimed to determine the effect of different ratios of BCTMP and REP1 to the characteristics of the SCK paper.

5 simulation trial points STP1-STP5 were created. In each of the trial points, the amount of BCP HW (birch) was kept at 35 wt. % of the fiber furnish and the amount of BCP SW (pine) was kept at 15 wt. % of the fiber furnish, while the amount BCTMP and REP1, independently, was varied from 5 to 45 wt. % of the fiber furnish, such that the combined amount of BCTMP and REP1 was 50 wt. % of the fiber furnish. In first trial point STP1 the amount of BCTMP was 45 wt. % and the amount of REP1 was 5 wt. % of the fiber furnish. The amount of REP1 was increased 5 wt. % units per trial point, while the amount of BCTMP decreased 10 wt. % units per trial point.

### Simulation 2—SCK Paper Wherein Amounts of All of the Fiber Furnish Components are Varied

A second series aimed to determine the effect to the characteristics of the SCK paper, when in addition to the amount of BCTMP and REP1, also the amount of BCP HW and BCP SW in the fiber furnish is changed. In particular, the amount of BCP SW was varied in the range of 5 to 25 wt. % of the fiber furnish.

5 simulation trial points STP6-STP10 were created. In the trial points STP6 and STP7, the amount of BCP HW (birch) was kept at 45 wt. % of the fiber furnish and the amount of BCP SW (pine) was kept at 5 wt. % of the fiber furnish, while the amount BCTMP was varied from 45 to 35 wt. % of the fiber furnish and the amount of REP1 was varied from 5 to 15 wt. % of the fiber furnish, such that the combined amount of BCTMP and REP1 was 50 wt. % of the fiber furnish.

In the trial point STP8, the amount of BCP HW (birch) was kept at 40 wt. % of the fiber furnish and the amount of BCP SW (pine) was kept at 10 wt. % of the fiber furnish, while the amount BCTMP and REP1, independently, was 25 wt. % of the fiber furnish, such that the combined amount of BCTMP and REP1 was 50 wt. % of the fiber furnish.

In the trial points STP9 and STP10, both the amount of BCP HW (birch) and the amount of BCP SW (pine) was independently kept at 25 wt. % of the fiber furnish, while the amount BCTMP was varied from 15 to 5 wt. % of the fiber furnish and the amount of REP1 was varied from 35 to 45 wt. % of the fiber furnish, such that the combined amount of BCTMP and REP1 was 50 wt. % of the fiber furnish.

Simulation 3—SCK Paper Wherein Majority of the Fiber Furnish is from a Combination of BCTMP and REP1

A third series aimed to determine the effect on a SCK paper when a majority of the fiber furnish contains a combination of BCTMP and REP1. An amount of 15 wt. % of BCP SW was maintained in the fiber furnish in all the simulation 3 trial points.

In the third series, 5 further simulation trial points STP11 to STP15 were created. In the trial points STP11-STP13, the amount of BCP HW (birch) was reduced from 35 wt. % to 25 wt. % of the fiber furnish, while BCP SW (pine) was kept at 15 wt. % of the fiber furnish. The amount BCTMP was maintained at 25 wt. % of the fiber furnish, while the amount of REP1 was increased from 25 to 35 wt. % of the fiber furnish, such that the combined amount of BCTMP and REP1 was 50 wt. % of the fiber furnish in the trial point STP11, 55 wt. % of the fiber furnish in the trial point STP12, and 60 wt. % of the fiber furnish in the trial point STP13.

In the trial points STP14 and STP15, the amount of BCP HW (birch) was no longer reduced from the 25 wt. % of the fiber furnish, but the amount BCTMP was reduced to 20 and 15 wt. % of the fiber furnish, while the amount of REP1 was increased to 40 and 45 wt. % of the fiber furnish, respectively, such that the combined amount of BCTMP and REP1 was 60 wt. % of the fiber furnish in both trial point STP14 and STP15.

### Simulation 4—SCK Paper Wherein BCTMP is the Major Component of the Fiber Furnish and the Combination of BCTMP and REP1 is in the Range of 50 to 70 wt. %

A fourth simulation aimed to determine the effect on a SCK paper when BCTMP is the major component and the fiber furnish contains a combination of BCTMP and REP1 in an amount of 60 wt. %. An amount of 15 wt. % of BCP SW was maintained in the fiber furnish in all the simulation 4 trial points.

In the fourth series, 5 further simulation trial points STP16 to STP20 were created. In the trial points STP16-STP20, the amount of BCP HW (birch) was reduced from 35 wt. % to 15 wt. % of the fiber furnish, while BCP SW (pine) was kept at 15 wt. % of the fiber furnish. The amount BCTMP was increased from 35 wt. % to 45 wt. % of the fiber furnish, while the amount of REP1 was varied in the range of 15 to 25 wt. % of the fiber furnish, such that the combined amount of BCTMP and REP1 was 60 wt. % of the fiber furnish, except in the trial points STP16 and STP20. In the trial point STP16, the combined amount of BCTMP and REP1 was 50 wt. % of the fiber furnish. In the trial point STP20, the combined amount of BCTMP and REP1 was 70 wt. % of the fiber furnish.

### Simulation 5—SCK Paper Wherein BCP HW is Replaced by BCTMP, While Maintaining the Share of BCP SW and REP1 Constant in the Fiber Furnish

A fifth simulation aimed to determine the effect on a SCK paper when the amount of BCP SW and REP1, each independently, is 15 wt. % of the fiber furnish, i.e. constant, but the ratio of BCP HW to BCTMP in the fiber furnish is changed, such that the combined amount of BCP HW and BCTMP is 70 wt. % of the fiber furnish.

In the fifth series, 5 further simulation trial points STP21 to STP25 were created. In the trial points STP21-STP25, the amount of BCP SW and REP1, each independently, was 15 wt. % of the fiber furnish. The amount of BCP HW (birch) was reduced from 65 wt. % to 25 wt. % of the fiber furnish, while the amount BCTMP was increased from 5 wt. % to 45 wt. % of the fiber furnish, such that in each of the simulation trial points STP21 to STP25, the combined amount of BCP HW and BCTMP was 70 wt. % of the fiber furnish.

### Results of the Experimental Study

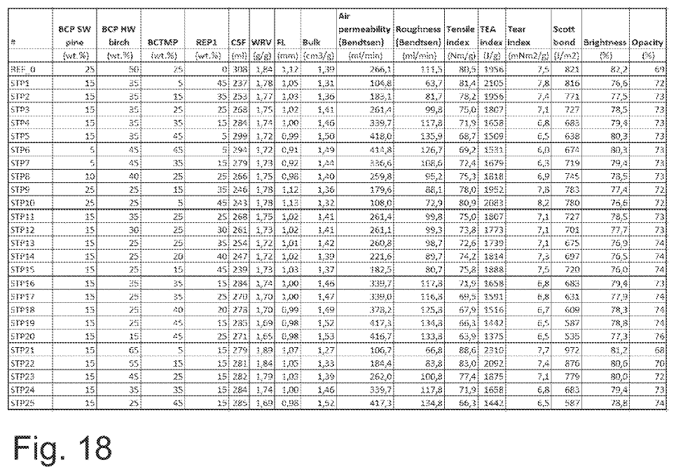

Results of the computational modelling are presented in FIG. 18. In the figure, the following abbreviations have been used for the SCK paper:

### Fiber Furnish Components:

BCP SW pine (wt. %)=non-recycled bleached chemical pulp from softwood which is pine, in units of weight percentage of the fiber furnish
BCP HW birch (wt. %)=non-recycled bleached chemical pulp from hardwood which is birch, in units of weight percentage of the fiber furnish
BCTMP (wt. %)=non-recycled bleached chemithermomechanical pulp from hardwood (aspen) and softwood (spruce), the value referring to weight percentage of the fiber furnish
REP1 (wt. %)=recycled pulp from supercalendered Kraft paper that has been used as a substrate of a release liner, in units of weight percentage of the fiber furnish

### Quality Parameters:

CSF=Canadian standard freeness, in units of millilitres (ml)
WRV=water retention value, in units of grams of water per grams of pulp (g/g)
FL=length weighted average fiber length, in units of millimeters (mm)
Bulk=reciprocal of density, in units of cubic centimeters per gram (cm^{3/}g)
Bendsen Air permeability, in units of millilitres per minute (ml/min)
Bendsen roughness, in units of millilitres per minute (ml/min)
Tensile index, in units of Newtonmeters per gram (Nm/g)
TEA=tensile energy absorption, in units of Joules per gram
Tear index=tearing strength/grammage, in units of milliNewtons times squaremeters per gram (mNm^{2/}g)
Scott bond test, in units of Joules per squaremeters (J/m²)
Paper brightness, in units of percentage
Paper opacity, in units of percentage

The simulation trial points STP1-STP5 indicated that a SCK paper comprising a fiber furnish, wherein the amount of BCP SW (pine) was kept at 15 wt. % of the fiber furnish and wherein the combined amount of BCTMP and REP1 was 50 wt. % of the fiber furnish, the paper bulk increased when the amount of BCTMP was higher than the amount of REP1. In addition, the water removal from the fibers was improved. When the amount of REP1 was higher than the amount of BCTMP, the freeness of the pulp decreased.

The simulation trial points STP9 and STP10 indicated that a SCK paper comprising a fiber furnish, wherein the majority of the fiber furnish was BCP SW (25 wt. %) and REP1 (in the range of 35 to 45 wt. % of the fiber furnish), the paper freeness and bulk were lower. On the other hand, the strength properties, tear index in particular, were very good. In the simulation trial points STP6 to STP8, wherein the majority of the fiber furnish was BCP HW (in the range of 40 to 45 wt. %) and BCTMP (in the range of 25 to 45 wt. %), the paper bulk was high. However, the strength properties were reduced and the sheet more porous, based on behaviour of the air permeability.

The simulation trial points STP12 to STP15 indicated that when the combined amount of BCTMP and REP1 was increased to 60 wt. % of the fiber furnish in a SCK paper, while maintaining at least an amount of 15 wt. % of BCP SW in the fiber furnish, the paper freeness decreases. On the other hand, surprisingly, in trial points where the amount of REP1 was over 2-fold compared to the amount of BCTMP, an increase in the strength properties, tear index in particular, was observed.

The simulation trial points STP16 to STP20 indicated that when the combined amount of BCTMP and REP1 was increased from 50 to 70 wt. % of the fiber furnish in a SCK paper, the water removal from the fibers could be further improved. This was particularly the case for the simulation trial points STP18 to STP20, wherein the amount BCTMP was at least 2 fold to the amount of REP1 in the fiber furnish. However, a decrease in the strength properties was observed.

The simulation trial points STP21 to STP25 indicated that in a SCK paper, which contains independently at least an amount of 15 wt. % BCP SW and REP1 in the fiber furnish, could also be amended by adjusting the amount of BCP HW and BCTMP in the fiber furnish. By increasing the combined amount of BCTMP and BCP HW from 50 to 70 wt. % of the fiber furnish, the water removal from the fibers could be also improved. However, the water retention value was higher than what could be achieved, when providing a fiber furnish with a higher amount of REP1. This could be observed by comparing the simulation trial points STP20 and STP25, from the series 4 and 5.

The results of the computational modelling indicate that BCTMP has a very high potential for providing bulk into a SCK paper, in comparison to non-recycled BCP, and also in comparison to recycled pulp obtained from RSCK. Due to relatively short but wide fibers and a relatively high lignin content of the BCTMP, the fibers are more rigid and support the SCK paper structure better than BCP, during supercalendering. The exceptional characteristics are also reflected in the water retention value, which BCTMP is able to suppress remarkably well, in particular when used in high amount and together with high amount of recycled pulp obtained from RSCK, as demonstrated by the series 4 samples STP17-STP20. This feature is reflected as easier water removing at the paper machine, during SCK paper production.

The results of the computational modelling further indicate that while recycled pulp obtained from RSCK differs structurally from non-recycled pulps, its characteristics resemble BHKP more than BCTMP, at least in terms of fiber length and potential for providing bulk. As noted above, the water retention value of recycled pulp obtained from RSCK is excellent. At a content in the range of 5 to 45 wt. % of the fiber furnish, recycled pulp obtained from RSCK may be used to substitute BHKP or BSKP in a fiber furnish of an SCK paper having a grammage in the range of 50 to 100 g/m², without adverse effects to other paper properties which would prevent its use as substrate layer of an industrial release liner for adhesive labels.

In particular, the results of the simulation indicate that when the content of the BCP in the fiber furnish remains constant and the ratio of BCTMP to recycled pulp obtained from RSCK is increased, the freeness of the pulp mixture is increased, while the water retention value is decreased. An increase in the bulk is also strongly associated with the increase in BCTMP.

The results evidence that optimization of the relative shares of non-recycled BCP, BCTMP, and recycled pulp obtained from obtained from RSCK enables production of SCK paper having a basis weight in the range of 50 to 100 g/m² such that the bulk and density of the formed paper web upon paper manufacturing may be controlled, without downgauging and without adverse effects to other paper properties which would prevent its use as substrate layer of an industrial release liner for adhesive labels.

The combined use of BCTMP and recycled pulp obtained from RSCK enables to maintain quality characteristics of supercalendered Kraft paper at a sufficient level, with enhanced sustainability and without reducing the basis weight of the paper upon manufacturing. In particular, a fiber furnish containing non-recycled bleached chemical pulp produced from softwood at least 15 wt. %, and further BCTMP and recycled pulp obtained from RSCK, each independently in the range of 5 to 40 wt. % when determined as dry matter content of the paper, may be supercalendered into a target thickness corresponding to similar kraft papers without BCTMP and recycled pulp obtained from RSCK, while maintaining sufficient quality characteristics for a use as substrate for a release liner.

### Experimental Study C2—Comparison of SCK Paper Fiber Furnishes Comprising BCP, BCTMP and Recycled Pulp Obtained from RSCK by Means of Laboratory Experiments

A further study was arranged to study the effects of recycled pulp obtained from RSCK, BCTMP, and their combination in SCK papers prepared in a laboratory scale. As a reference LPTO, a test specimen comprising 35 wt. % BSKP (pine) and 65 wt. % BHKP (eucalyptus) was prepared. Subsequently, a set of 11 different SCK paper test specimens LPT1 to LPT11 were prepared. The reference and the set were prepared in two different basis weights of 58 g/m² and 62 g/m². The fiber furnish composition of the test specimens used in the study are defined in Table 15 (below).

TABLE 15
Fiber furnish composition of test specimens prepared in the experimental study C2.

| | BSKP | | BHKP | | BCTMP | | REP1 | |
|---|---|---|---|---|---|---|---|---|
| | wt. % | °SR | wt. % | SR | wt. % | °SR | wt. % | °SR |
| LTP0 | 35 | 35 | 65 | 50 | — | | — | |
| LTP1 | 30 | 35 | 55 | 50 | — | | 15 | 62 |
| LTP2 | 30 | 30 | 55 | 50 | — | | 15 | 62 |
| LTP3 | 30 | 25 | 55 | 50 | — | | 15 | 62 |
| LTP4 | 25 | 35 | 45 | 50 | — | | 30 | 62 |
| LTP5 | 25 | 30 | 45 | 50 | — | | 30 | 62 |
| LTP6 | 25 | 25 | 45 | 50 | — | | 30 | 62 |
| LTP7 | 30 | 30 | 55 | 45 | — | | 15 | 62 |
| LTP8 | 30 | 30 | 55 | 40 | — | | 15 | 62 |
| LTP9 | 30 | 35 | 45 | 50 | 25 | 45 | — | |
| LTP10 | 25 | 35 | 35 | 50 | 25 | 45 | 15 | 62 |
| LTP11 | 20 | 35 | 25 | 50 | 25 | 45 | 30 | 62 |

The abbreviation wt.% refers to the weight percentage of the pulp component in the fiber furnish.
The abbreviation °SR refers to the target Schopper-Riegler value.
BSKP = bleached softwood kraft pulp (pine)

The BCTMP used in the experiment was a mixture made of hardwood (aspen) and softwood (spruce), wherein the share of softwood was 20 wt. %. The test specimens were prepared according to ISO 5269-3 (2008) standard, using a conventional sheet-former as described in ISO 5269-1 (2005). Refining of BSKP, BHKP and BCTMP was performed with a Voith-Sulzer laboratory refiner (4% pulp consistency) to defined target °SR. After dewatering and drying (pressing the sheets between blotters according to the standard) all the formed handsheets were conditioned overnight (RH 90%, +23° C.) and then calendered (100° C. roll temperature, 4000 dN pressure, 2 passes) such that test specimens having a target thickness in the range of 51 to 56 micrometers were obtained.

An analysis of the properties of the fiber furnish compositions, prior to formation of the handsheets indicated that in all test specimens where recycled pulp obtained from RSCK or BCTMP was present, the length weighted averaged fiber length decreased. This was the case in particular for cases LTP9, LTP10 and LTP11, where both BCTMP and recycled pulp obtained from RSCK were present. Compared to the reference LTPO, in test specimens LTP1 to LTP8, where recycled pulp obtained from RSCK was present, the length weighted averaged fiber length was on average 0.04 mm less than in the reference LTPO. In test specimens LTP10 and LTP11, where both recycled pulp obtained from RSCK and BCTMP was present, the length weighted averaged fiber length was on average 0.06 mm less than in the reference LTPO. BCTMP appeared to have a large contribution to the fiber length, based on the sample LTP8, wherein the length weighted averaged fiber length was on 0.05 mm less than in the reference LTPO. The same tendency could also be observed in the test specimens as an increase in the share of shorter fiber fractions, especially fines having a fiber length between of 0 and 0.2 mm. The analysis also demonstrated that when the amount of BSKP and/or BHKP was reduced and the amount of BCTMP and/or recycled pulp obtained from RSCK was correspondingly increased in the test specimens, the water retention level of the pulp was reduced.

Laboratory tests performed on the SCK paper test specimens indicated that when both recycled pulp obtained from RSCK and BCTMP was present in the fiber furnish, the bulking thickness of uncalendered sheets increased. A largest contribution to bulk was evidenced both in the uncalendered and calendered sheets where BCTMP was present, which was in line with the results obtained from the computational modelling, wherein higher bulk values were also correlating with higher amount of BCTMP in the fiber furnish.

The laboratory tests performed on the SCK paper test specimens further indicated a change in the opacity and transparency values in calendered test specimens containing both recycled pulp obtained from RSCK and BCTMP.

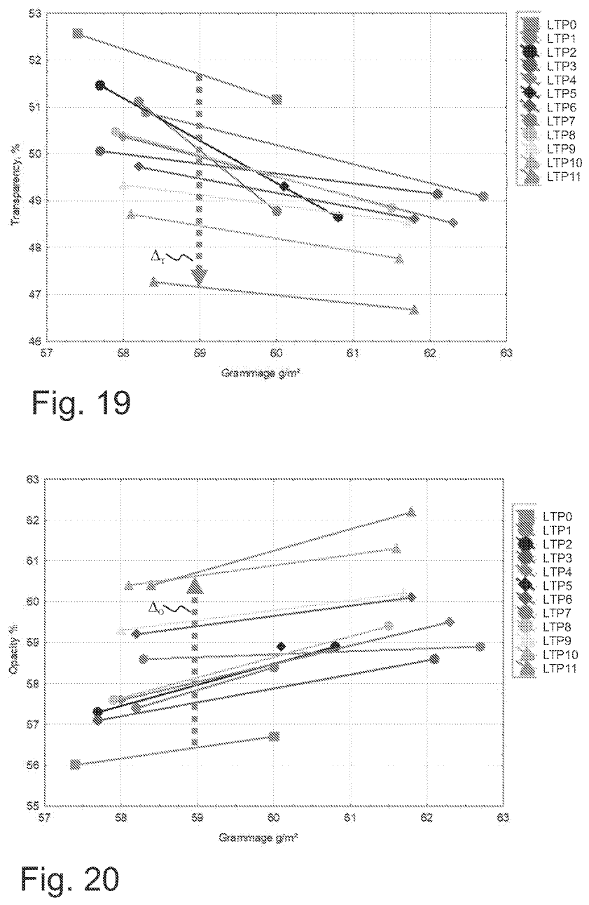

Reference is made to FIGS. 19 and 20, which show a decrease in the transparency AT of the calendered test specimens LTP10 and LTP11, compared to the reference LTPO (FIG. 19) and a corresponding increase in the opacity Ao of the calendered test specimens LTP10 and LTP11, compared to the reference LTPO (FIG. 20). However, as evident from the figures, despite comprising considerable amounts of recycled pulp obtained from RSCK and BCTMP, the calendered test specimens LTP10 and LTP11 still maintained a transparency which was 46% or higher, and sufficient for use as a substrate of a release liner.

The laboratory tests performed on the SCK paper test specimens further indicated that while the addition of BCTMP and pulp obtained from RSCK into the fiber furnish reduces the strength of the paper, when determined as a tear index, this could be compensated by lowering the refining of non-recycled BCP pulp, part non-recycled BCP obtained from softwood. The tear strength could be maintained sufficiently throughout the trial point, while replacing non-recycled BCP with recycled pulp obtained from RSCK. The tear strength could be maintained even when the amount of recycled pulp obtained from RSCK was 30 wt. % of the fiber furnish, by adjusting the content of non-recycled BCP produced from softwood to a level of at least 15 wt. % of the fiber furnish, preferably in the range of 15 to 20 wt. % of the fiber furnish. Tear index, expressed in millinewton square metres per gram (mN·m^{2/}g), refers to the tearing resistance of the paper divided by its grammage. Tearing resistance is defined as the mean force per sheet required to continue the tearing started by an initial cut in the test piece and is determinable according to ISO 1974:2012(en).

The results of the laboratory tests thus further strengthened the perception already received from the computational modelling disclosed above. Taken together, the results above evidence that the density and transparency of a SCK paper can be controlled by means of introducing considerable amounts of BCTMP and recycled pulp obtained from RSCK into the fiber furnish, particularly when the share of non-recycled BCP produced from softwood is maintained at a sufficient level. This enables production of SCK paper more sustainably, without downgauging and without adverse effects to other paper properties, such as transparency, which would prevent its use as substrate layer of an industrial release liner for adhesive labels.

The combined use of BCTMP, non-recycled BCP produced from softwood and recycled pulp obtained from RSCK enables to maintain quality characteristics of supercalendered Kraft paper at a sufficient level, with enhanced sustainability and without reducing the basis weight of the paper upon manufacturing.

The claimed invention has been described with the aid of illustrations and examples. The methods or any product obtained by the methods are not limited solely to the above presented examples but may be modified within the scope of the appended claims.

1. A supercalendered Kraft paper suitable for use as a substrate of a release liner, the supercalendered Kraft paper having
a grammage in the range of 50 to 100 g/m², determinable according to ISO 53
a density equal to or higher than 1.030 g/cm³, determinable according to ISO 534,
a transparency equal to or higher than 36%, determinable according to ISO 2469, and a fiber furnish determinable with standard ISO 9184-4 in conjunction with standard ISO 9184-1, the fiber furnish comprising
an amount equal to or higher than 5 wt. % of non-recycled bleached chemithermomechanical pulp, and
an an amount equal to or higher than 5 wt. % of recycled pulp obtained from release liner supercalendered Kraft paper, the fiber furnish further comprising
an non-recycled bleached chemical pulp produced from hardwood,
an non-recycled bleached chemical pulp produced from softwood, or
an non-recycled bleached chemical pulp produced from hardwood and softwood,
an the amounts determinable as dry matter content according to SCAN-P 39:80.

2. A method for manufacturing supercalendered Kraft paper suitable for use as a substrate of a release liner, the method comprising
mixing pulps such that a stock comprising a fiber furnish is obtained, the fiber furnish determinable with standard ISO 9184-4 in conjunction with standard ISO 9184-1, the fiber furnish comprising
an amount equal to or higher than 5 wt. % of non-recycled bleached chemithermomechanical pulp,
an amount equal to or higher than 5 wt. % of recycled pulp obtained from release liner supercalendered Kraft paper, and
non-recycled bleached chemical pulp produced from hardwood,
non-recycled bleached chemical pulp produced from softwood or
non-recycled bleached chemical pulp produced from hardwood and softwood, the amounts determinable as dry matter content according to SCAN-P 39:80,
forming a paper web of the stock on a paper machine,
reducing moisture content of the paper web (WEBI)-in a press section,
drying the paper web in a drying section, thereby forming paper, and
supercalendering the paper, thereby forming supercalendered Kraft paper having
a grammage in the range of 50 to 100 g/m², determinable according to ISO 53
a density equal to or higher than 1.030 g/cm³, determinable according to ISO 534, and
a transparency equal to or higher than 36%, determinable according to ISO 2469.

3. The method according to claim 2, the recycled pulp obtained from release liner supercalendered Kraft paper, prior to the mixing, having a Schopper-Riegler number equal to or higher than 25, when determined according to ISO 5267-1.

4. The method according to claim 2, the non-recycled bleached chemithermomechanical pulp , prior to the mixing, having a Schopper-Riegler number equal to or less than 60, when determined according to ISO 5267-1.

5. The method according to claim 2, wherein the recycled pulp obtained from release liner supercalendered Kraft paper contains particles derived from the recycled pulp having a length less than 200 micrometers in an amount equal to or higher than 10%, of the total amount of fibers in the recycled pulp, when determined as length weighted average fiber length by automated optical analysis using unpolarized light according to ISO 16065-2:2014.

6. The method according to claim 2, wherein fibers of the recycled pulp obtained from release liner supercalendered Kraft paper have an average fiber width of less than 25 micrometers, when determined by automated optical analysis using unpolarized light according to ISO 16065-2:2014.

7. The method according to claim 2, wherein the non-recycled bleached chemical pulp produced from softwood, prior to the mixing, has a Schopper-Riegler number equal to or less than 50, when determined according to ISO 5267-1.

8. The method according to claim 2, wherein the stock at a machine chest of a paper machine has a water retention value which is in the range of 1.5 to 1.9 g/g, determinable according to ISO 23714:2014 from a sample having a dry matter content of 1 gram.

9. The paper according to claim 1, the supercalendered Kraft paper comprising the recycled pulp obtained from release liner supercalendered Kraft paper in the range of 5 to 40 wt. %, when determined as dry matter content according to SCAN-P 39:80.

10. The paper or the method according to claim 1, the supercalendered Kraft paper comprising the non-recycled bleached chemithermomechanical pulp in the range of 5 to 40 wt. %, when determined as dry matter content according to SCAN-P 39:80.

11. The paper according to claim 1, wherein the fiber furnish comprises an amount equal to or higher than 15 wt. %, of non-recycled bleached chemical pulp produced from softwood, when determined as dry matter content according to SCAN-P 39:80.

12. The according to claim 2, wherein the fiber furnish has an average length weighted fiber length equal to or higher than 0.98 mm, when determined according to ISO 16065-2:2014.

13. The paper according to claim 1, the bleached chemithermomechanical pulp comprising fibers from softwood, the softwood being a coniferous tree.

14. The paper according to claim 1, the bleached chemithermomechanical pulp comprising fibers from hardwood, the hardwood being a broadleaved tree.

15. The paper or the method according to claim 1, wherein the recycled pulp obtained from supercalendered Kraft paper that has been used as a substrate of a release liner has not been bleached.

16. A release liner comprising a substrate layer and a release coating, wherein the substrate layer is a supercalendered Kraft paper according to claim 1, which comprises a primer coating applied on at least one side of the supercalendered Kraft paper.

17. A method of using recycled pulp obtained from release liner supercalendered Kraft paper in combination with non-recycled bleached chemithermomechanical pulp in a method for manufacturing supercalendered Kraft paper suitable for use as a substrate of a release liner.

18. The method according to claim 2, wherein the recycled pulp obtained from supercalendered Kraft paper that has been used as a substrate of a release liner has not been bleached.

19. The paper according to claim 1, wherein the fiber furnish comprises an amount in the range of 15 to 20 wt-% of non-recycled bleached chemical pulp produced from softwood, when determined as dry matter content according to SCAN-P 39:80.

20. The paper according to claim 1, wherein the paper contains silicon in an amount in the range of 0.01 to 0.3 wt. %, determinable as dry matter content from a paper specimen which is combusted at 900° C. with an Energy Dispersive X-ray Spectroscopy, in accordance with Tappi standard T 413.
